(19) United States
(12) Patent Application Publication
(10) Pub. No.: US 2026/0358759 A1
(43) Pub. Date: Nov. 12, 2026

(54) COLOR HOLOGRAPHY USING A SINGLE ARRAY OF LIGHT MODULATION ELEMENTS WITHOUT COLOR FILTERS

(71) Applicant: Swave BV, Leuven (BE)

(72) Inventor: Andrzej Kaczorowski, Leuven (BE)

(73) Assignee: Swave BV, Leuven (BE)

(21) Appl. No.: 19/654,855

(22) Filed: Apr. 22, 2026

Related U.S. Application Data
(60) Provisional application No. 63/802,768, filed on May 9, 2025.

(51) Int. Cl. G03H 1/30; G03H 1/02

(52) U.S. Cl. CPC G03H 1/30; G03H 1/02; G03H 2001/0224; G03H 2001/303; G03H 2225/61

(57) ABSTRACT

Disclosed herein are systems and methods for performing color holography using a single array of light modulation elements without color filters. An example holographic display system includes an illumination source and a light modulation structure comprising an array of light modulation elements, wherein a first light beam from the illumination source has a first center wavelength and is incident onto the light modulation structure along a first direction, a second light beam from the illumination source has a second center wavelength and is incident onto the light modulation structure along a second direction, and the second center wavelength is different from the first center wavelength. In some embodiments, an angle between a plane comprising the first direction and a line perpendicular to the light modulation structure and a plane comprising the second direction and the line perpendicular to the light modulation structure is greater than 0 degrees.

### CROSS-REFERENCE TO RELATED APPLICATION

This application claims the benefit of U.S. Provisional Patent App. No. 63/802,768, entitled “COLOR HOLOGRAPHY USING A SINGLE ARRAY OF LIGHT MODULATION ELEMENTS WITHOUT COLOR FILTERS,” filed on May. 9, 2025, the disclosure of which is expressly incorporated herein by reference in its entirety.

### BACKGROUND

Color holography refers to the process of creating holographically-generated images that reproduce a spectrum of colors, rather than appearing only in monochrome. A hologram is a light interference pattern that encodes the amplitude and/or phase information of light scattered from a three-dimensional (3D) object, enabling the reconstruction of a realistic 3D image when appropriately illuminated. In an example of color holography, this reconstruction occurs simultaneously for red, green, and blue (RGB) wavelengths - the primary colors of light that, when combined, can recreate a visible color range.

In digital holography (also referred to as “computer-generated holography (CGH)”), a spatial light modulator (SLM) plays a central role by dynamically encoding the amplitude information of a light interference pattern, the phase information of a light interference pattern, or both the amplitude and phase information. Color holography is realized by generating multiple holographically-generated images, each for a different wavelength of light (e.g., for red, green, and blue light), and aligning these holographically-generated images so that they overlap to realize a non-monochrome holographically-generated image. An SLM includes an array of individually addressable light modulation elements (sometimes referred to as “SLM pixels” or simply “pixels”), each capable of modulating the incoming light according to a programmed hologram pattern. Building an efficient SLM-based system for color holography is a complex challenge that requires considerable ingenuity and careful design to ensure high image quality, color fidelity, and efficient use of available pixel area.

### BRIEF DESCRIPTION OF THE DRAWINGS

Embodiments will be readily understood by the following detailed description in ‎conjunction with the accompanying drawings. To facilitate this description, like reference ‎numerals designate like structural elements. Embodiments are illustrated by way of ‎example, and not by way of limitation, in the figures of the accompanying drawings.

FIG. 1 provides a schematic illustration of a holographic display system, according to some embodiments.

FIG. 2 provides a cross-sectional side view of an example SLM array, according to some embodiments.

FIG. 3 is a schematic illustration of an example data processing system configured to control operation of a holographic display system, according to some embodiments.

FIGS. 4A-4H illustrate a basic framework behind performing color holography using a single array of light modulation elements without color filters operable with wavelength-multiplexed illumination, according to some embodiments.

FIGS. 5A and 5B provide schematic illustrations of methods implemented by one or more computing systems for generating digital hologram patterns for a single array of light modulation elements without color filters, according to some embodiments.

FIG. 6 illustrates an image within a signal window within a replay field for hologram computation, according to some embodiments.

FIG. 7 provides illustrations of example resized input images for hologram computation for different color channels, according to some embodiments.

FIG. 8 provides an illustration of a superposition of the resized input images of FIG. 7, according to some embodiments.

FIG. 9 provides illustrations of reconstructed images resulting from illumination by only red, only green, and only blue light, according to some embodiments.

FIG. 10 provides an illustration of a superposition of the reconstructed images of FIG. 9, according to some embodiments.

FIG. 11 provides a summary of color holography with and without color filters, according to some embodiments.

### DETAILED DESCRIPTION

Disclosed herein are systems and methods for performing color holography using a single array of light modulation elements without color filters. These systems and methods are compatible with time-sequential illumination of two or more wavelengths of light, but they do not require time-sequential illumination with different wavelengths and are operable with wavelength-multiplexed illumination. The systems, methods, and devices of this disclosure each have several innovative aspects, no single one of which is solely responsible for all the desirable attributes disclosed herein. Details of one or more implementations of the subject matter described in this specification are set forth in the description below and the accompanying drawings.

For purposes of illustrating color holography using a single array of light modulation elements without color filters operable with wavelength-multiplexed illumination proposed herein, it might be useful to first understand phenomena that may come into play in color holography. The following foundational information may be viewed as a basis from which the present disclosure may be properly explained. Such information is offered for purposes of explanation only and, accordingly, should not be construed in any way to limit the broad scope of the present disclosure and its potential applications.

In conventional color displays, such as LCDs, OLEDs, and microLED panels, full-color images are produced by intermixing red, green, and blue (RGB) subpixels. Each display pixel is composed of three tiny subpixels — one that emits red light, one green, and one blue. These subpixels are placed extremely close together, and the display controls the intensity (brightness) of each subpixel individually. This technique works because of how the human visual system interprets color. Our eyes contain three types of cone cells, each sensitive to different portions of the light spectrum (roughly red, green, and blue). When light from the red, green, and blue subpixels enters the eye and stimulates these cones in different amounts, the brain blends the signals together and perceives a single color. This process is known as additive color mixing. Because the subpixels are so small and closely spaced, the eye cannot resolve them separately at a normal viewing distance. Instead, it perceives a single, uniform color resulting from the mixture of light from the RGB subpixels. For example, if the red and green subpixels are turned on at full brightness while the blue subpixel is off, the eye perceives yellow. If all three subpixels are illuminated equally, the eye perceives white.

This RGB subpixel strategy is fundamental to the operation of nearly all modern digital displays, and the principle of assigning subregions of the active area of a display to be operable for only one of a set of colors can be adapted in CGH using SLMs when color filters are used to, for example, spatially separate and control red, green, and blue diffracted light components to create RGB-color holographically-generated images. To achieve color holography, the active area of the SLM can be divided into subregions, with different subregions modulating different color components — for example, some subregions modulate red light, others green, and others blue. The size of these subregions can be as small as a single SLM pixel or can cover multiple SLM pixels. To that end, some SLMs utilize color filters placed over the pixels to selectively pass only one of a set of wavelengths (e.g., only pass one of the RGB colors) at each SLM pixel location, allowing the SLM to spatially multiplex the colors. During operation, the SLM (e.g., the entire SLM active area) can be illuminated simultaneously or sequentially with red, green, and blue laser light. Only the pixels covered by the matching color filter modulate the corresponding wavelength of light, e.g., red light is modulated by red-filtered pixels, green light by green-filtered pixels, and blue light by blue-filtered pixels. By carefully designing the hologram to account for the spatial arrangement of the red, green, and blue pixels, a multi-color holographically-generated image can be reconstructed. With color holography, the holographically-generated image of a first wavelength can overlap with the holographically-generated image of a second wavelength, different from the first wavelength, and as a result, the human visual system will perceive a non-monochrome holographically-generated image. For example, in the case of red, green, and blue illumination, the reconstructed image for the red illumination, the reconstructed image for the green illumination, and the reconstructed image for the blue illumination will overlap for the human visual system to perceive a single RGB-color image.

While CGH using SLMs with color filters may enable color reproduction, it introduces significant technical challenges. Because only one-third of the pixels actively modulate light for each color at any given time, the effective modulation area is greatly reduced, which decreases contrast, efficiency, and effective resolution. Additionally, since much of the incident light is blocked by the non-matching filters, there is a major loss of optical power. Further complications arise because the color filter pattern can introduce artifacts such as white balance fluctuations depending on the observer’s pupil position with respect to the color filters, background noise from point spread function (PSF) side-lobes (resulting in a blurred image), and inconsistent color rendering. These limitations collectively mean that while color filters enable practical color holography, they also impose substantial penalties on image quality, system performance, and optical efficiency.

One approach to realizing color holography without using color filters may include employing separate holograms for two or more colors, for example, separate holograms for each of the primary colors — red, green, and blue. In this approach, distinct arrays of light modulation elements (e.g., separate sub-arrays on a single SLM or multiple SLMs) are assigned to encode individual holograms corresponding to each wavelength. When illuminated with the respective light sources (e.g., coherent or partially-coherent light sources), these holograms reconstruct the red, green, and blue components of the image, which can then be optically superimposed to produce an RGB-color holographically-generated image. While this method may eliminate the need for conventional color filtering, it may impose significant trade-offs. For example, the hardware complexity may increase due to the need for multiple high-resolution modulation arrays and/or more sophisticated SLM driving schemes, power consumption may rise with the operation of an increased number of light modulation elements, and the computational burden may escalate due to the need to generate and process three separate holograms in parallel.

Another approach to realizing color holography without using color filters may include using a single SLM and illuminating it sequentially with light (e.g., coherent or partially-coherent light) of different wavelengths, for example, different wavelengths representing primary colors, a process sometimes referred to as “temporal multiplexing.” In this approach, separate holograms for the red, green, and blue color channels are displayed on an SLM in rapid succession. In this approach, the SLM is programmed to modulate light for one color at a time and is sequentially illuminated by light sources of the corresponding wavelengths. For each color, a unique hologram is calculated and displayed on the SLM while the appropriate illumination source illuminates it, reconstructing a monochromatic version of the full scene. These individual reconstructions are presented in quick succession, fast enough that the human visual system temporally integrates them into a single, multi-color holographically-generated image. While sequential color illumination with a single SLM may enable high-quality color holography without the drawbacks of color filters, it comes at the cost of increased frame time, which effectively reduces the overall frame rate of the display (e.g., reduces the overall frame rate of the reconstructed RGB images). Since each color image is composed of three separate holograms (e.g., one for red, one for green, and one for blue), the system must cycle through all three before completing a single color frame. This means that if the SLM operates at a given frequency (e.g., 180 Hz), each color channel only gets one-third of that frequency (e.g., 60 Hz), resulting in a color refresh rate of a smaller number of frames per second (e.g., just 60 frames per second). In practical systems where the SLM or laser drivers are not fast enough, the effective frame rate may be even lower, leading to motion artifacts, flicker, or latency, especially in dynamic or interactive content. This limitation is particularly problematic for applications such as augmented reality (AR) or virtual reality (VR), where low latency and high frame rates are critical for user comfort and immersion. In other embodiments, it may be decided to increase the frame rate of the SLM in combination with sequential illumination in order to still achieve a desired frame rate of the display (a desired frame rate of the reconstructed RGB images). However, having the SLM operate at a higher frame rate may come at a cost of having a higher power consumption for the overall system.

Embodiments of the present disclosure are based on recognition that a single array of light modulation elements without color filters and without using sequential illumination may be used for color holography if light beams of different wavelengths (for example, red, green, and blue light) are separated to be incident on the SLM array at different directions and if the hologram patterns for the red, green, and blue color channels of a target image are added together to form a single hologram pattern that incorporates the information of the red, green, and blue color channels of the target image (e.g., a hologram pattern may be obtained by adding outputs of Fast Fourier Transforms (FFTs) for individual primary colors together in a single hologram pattern). One advantage of eliminating color filters in a holographic display system without the drawbacks that would be associated with sequential illumination or use of multiple SLMs may be the significant improvement in image quality. Without color filters, issues such as resolution loss, blurred images due to an extended PSF, color non-uniformities when the pupil moves relative to the color filters and each area where the pupil intercepts with the color filters has different color coverage percentages, and unnatural accommodation effects may be avoided. In some embodiments, the process of hologram generation may be more computationally efficient since quantization—a key step in hologram generation—is only performed on a single hologram that incorporates the holographic information for all three colors, rather than on the hologram pattern associated with each color separately. This approach may come with trade-offs such as the reduction in available field of view (FoV), potentially lower contrast due to a higher average pixel level, and increased complexity due to illumination by different wavelengths from different angles. However, in many practical implementations, the benefits are likely to outweigh the cons. Most applications do not utilize the very large FoV that can be generated by an SLM having a very small pixel pitch (e.g., a pixel pitch below the wavelength of visible light, or below half the wavelength of visible light), so the reduction may not be noticeable. The gain in perceived resolution, uniformity, and simplicity—both in spatial light modulator hardware (no filters, fewer artifacts) and software (unified processing)—can lead to more robust, efficient, and visually pleasing systems. Clever optical design can also mitigate the need for complex laser arrangements, making this approach attractive for real-world use. An example holographic display system in accordance with embodiments of the present disclosure may include an illumination source and a light modulation structure comprising an array of light modulation elements, wherein a first light beam from the illumination source has a first center wavelength and is incident onto the light modulation structure along a first direction, a second light beam from the illumination source has a second center wavelength and is incident onto the light modulation structure along a second direction, and the second center wavelength is different from the first center wavelength. In some embodiments, an angle between a plane comprising the first direction and a line perpendicular to the light modulation structure and a plane comprising the second direction and the line perpendicular to the light modulation structure is greater than 0 degrees (in other words, the second direction is not parallel to the first direction; or, phrased differently, a projection of the first direction onto a plane of, or parallel to, the light modulation structure is different from a projection of the second direction onto that plane). In some embodiments, the first direction is at a first angle with respect to a plane of the light modulation structure, the second direction is at a second angle with respect to the plane of the light modulation structure, and the second angle is different from the first angle. In some embodiments, an angle between a plane comprising the first direction and a line perpendicular to the light modulation structure and a plane comprising the second direction and the line perpendicular to the light modulation structure is greater than 0 degrees, the first direction is at a first angle with respect to a plane of the light modulation structure, the second direction is at a second angle with respect to the plane of the light modulation structure, and the second angle is different from the first angle.

While some explanations provided herein refer to using FFTs for hologram generation, embodiments of the present disclosure are equally applicable to alternative CGH algorithmic methods, such as, but not limited to, different types of point-cloud CGH methods, different types of layer-based CGH methods, different types of polygon-based CGH methods, different types of neural network-based CGH methods, and different types of machine learning-based CGH methods. While some explanations provided herein refer to using phase change materials in an SLM array, embodiments of the present disclosure are equally applicable to alternative types of realizing SLM pixels, such as quantum well-based SLMs, liquid crystal (LC)-based SLMs, or microelectromechanical systems (MEMS)-based SLMs. Furthermore, while some explanations provided herein refer to using red, green, and blue light, embodiments of the present disclosure are equally applicable to other selections of two or more wavelengths.

To facilitate understanding of the illustrative implementations, certain numerical values, materials, and configurations are provided by way of example. However, it will be understood by those skilled in the art that the disclosed concepts can be implemented without relying on these specific details, or by applying only selected aspects thereof. Additionally, commonly known features and components may be omitted or presented in a simplified manner so as not to detract from the clarity of the illustrative embodiments.

In the following detailed description, various aspects of the illustrative implementations may be described using terms commonly employed by those skilled in the art to convey the substance of their work to others skilled in the art. For example, in the context of CGH, the term “hologram” or “hologram pattern” refers to a digitally computed two-dimensional pattern comprising modulated optical properties such as phase, amplitude, or a combination thereof, designed to diffract incident light in a manner that reconstructs a desired optical wavefront corresponding to a target image. Such a hologram may be generated using numerical wave propagation techniques (e.g., Fourier or Fresnel transforms) based on a virtual representation of a target image. To embody a computer-generated hologram, one or more physical/operational states (e.g., refractive index, orientation, or optical path length) of individual pixels of an SLM array are electronically programmed according to the information contained in the hologram. This programming enables the SLM pixels to alter specific optical properties of light illuminating them to modulate the amplitude and/or phase (and in some cases, and/or the polarization) of the light passing through or reflected from each SLM pixel. When light modulated by the SLM is projected into space, these programmed alterations collectively shape the wavefront to reconstruct the intended 3D image, thereby transforming the SLM into a dynamic, reconfigurable medium for holographic projection. As used herein, the term “SLM array” may refer to or be used interchangeably with terms such as “SLM,” “an array of light modulation elements,” or “an array of unit cells.” Additionally, the term “SLM pixel” may be used interchangeably with “pixel,” “light modulation element,” or “unit cell.” As used herein, descriptions of a plane of the SLM array refer to the plane of the SLM array or any plane that is parallel to the surface of the SLM array (e.g., any of the x-y planes of the example coordinate system shown in the present drawings). As used herein, descriptions of a plane perpendicular to the SLM array refer to any plane that is perpendicular to the plane of the SLM array (e.g., any of the y-z or x-z planes of the example coordinate system shown in the present drawings).

In another example, the term “image” as used in reference to a target image or to a reconstructed image refers to a virtual representation of a scene that may be two-dimensional (2D) or 3D in nature. Such a scene may include one or more objects, each defined by spatial attributes such as shape, texture, depth, color, and optical properties (e.g., reflectance, transparency). A 2D image typically resides on a single plane and encodes visual content without depth cues, whereas a 3D image includes volumetric or multi-depth information that enables realistic depth perception when reconstructed. The image may be static or dynamic (time-varying) and may include multiple depth layers or continuous depth encoding depending on the system's capabilities. In this context, the target image is an image that serves as the basis for numerical wavefront calculations, while the reconstructed image refers to the optical output produced by the hologram when illuminated, which recreates the intended visual appearance of the original scene through diffraction and interference. The reconstructed image can exhibit parallax, occlusion, and depth-dependent focus cues, thereby supporting perception of real-world spatial structures. The term “reconstructed image” may be used interchangeably with expressions such as “reconstructed holographic scene,” “reconstructed holographic scene/imagery,” “reconstructed scene/imagery,” “reconstructed virtual scene/imagery,” “virtual scene/imagery,” “virtual content,” or “holographically-generated image”.

The term “replay field” (RPF) refers to the spatial region where the reconstructed image (holographically-generated scene) appears after the hologram is illuminated (or "replayed") by the appropriate light sources. This field represents the volume or area in the 3D space in which a target image is displayed for a user to perceive. In some embodiments, the term “reconstructed image” refers to a portion of the replay field, for example, a portion intended to be visible to a user. In other embodiments, the term “reconstructed image” refers to the portion of the replay field arising from first-order diffracted light, excluding any conjugate (twin) image, if present. In alternative embodiments, the term “reconstructed image” refers to the entire replay field. In some embodiments, the system is configured to make use of or to make visible both images arising from first-order diffracted light and images arising from second-order diffracted light.

As used herein, the term “light” generally refers to electromagnetic radiation within the visible spectrum that is used to illuminate an SLM or to reconstruct a holographically-generated image. The ideal source of light for generating and reconstructing holographically-generated images is light with one or more discrete wavelengths, such as that produced by a laser. For example, a multi-wavelength laser may be designed to produce light having one component having a wavelength of about 625 nm (red light), one component having a wavelength of about 530 nm (green light), and one component having a wavelength of about 460 nm (blue light), which is an example of a light source producing three discrete wavelengths. In another example, a single-wavelength laser may be designed to produce light of only one discrete wavelength, e.g., 625 nm (red light). However, practical implementations may utilize light sources that emit within a narrow non-zero spectral bandwidth around each discrete wavelength. For example, a laser designed to emit light at a certain wavelength does not only emit light of that one exact wavelength but emits light that is centered around that wavelength in a narrow but non-zero bandwidth (e.g., 5 nm). In such cases, the term “wavelength of the light” refers to the central wavelength of the spectral distribution. For a given discrete wavelength, this narrowband light may still be considered effectively monochromatic for holographic purposes, provided that the bandwidth is sufficiently small to preserve coherence over the spatial and temporal scales relevant to hologram formation and reconstruction. In some embodiments, the spectral bandwidth of individual discrete wavelengths of light described herein may include a range of wavelengths within (i.e., ±) 1 nanometer (nm), from the central wavelength, e.g., within ± 300 picometers (pm) or within 30 pm. The term “light” may refer to, or be used interchangeably with, expressions such as “light beam,” “optical radiation,” “illumination,” “coherent light,” or “partially-coherent light,” particularly when discussing propagation through or modulation by optical components within the system.

Terms such as “substantially,” “approximately,” “close,” “near,” and “about” generally indicate values within ±10%, e.g., within ±5% or ±2%, of a given target, depending on the particular context or established conventions in the field. Similarly, spatial descriptors like “coplanar,” “perpendicular,” “parallel,” “orthogonal,” or similar terms describing angular relationships should be interpreted as allowing for minor deviations within similar tolerances. Terms describing spatial relationships, such as “over,” “under,” “between,” and “on,” refer to relative positioning of one material layer or component with respect to other layers or components. For instance, one layer disposed over or under another layer may be directly in contact with the other layer or may have one or more intervening layers. Moreover, one layer disposed between two layers may be directly in contact with the two layers or may have one or more intervening layers. In contrast, a first layer or component described to be “on” a second layer or component is in direct contact (e.g., in direct physical contact) with that second layer or component. Similarly, unless explicitly stated otherwise, one feature disposed between two features may be in direct contact (e.g., in direct physical contact) with the adjacent features or may have one or more intervening layers.

For clarity, the expression “A and/or B” should be understood to include (A), (B), or (A and B). Likewise, “A, B, and/or C” covers all possible combinations of those elements, including each individually and all together. When ranges are expressed using the term “between,” the range includes the boundary values unless specified otherwise. The notation “A/B/C” should be interpreted to include any of A, B, or C, alone or in combination. Terms presented in the singular should be understood to encompass the plural unless the context dictates otherwise. For example, “a phase change material” may involve one or more such materials. Similarly, “an insulator material” may refer to one or more insulating substances. The term “insulating,” as well as variations like “insulative” or “insulator,” is used to mean “electrically insulating” unless otherwise noted. Conversely, “conducting” or “conductive” refers to materials that are electrically conductive. For example, the term “insulator material” may denote solid or process-solidified liquid substances that exhibit electrical non-conductivity.

The disclosure may use the terms “in an embodiment” or “in embodiments” to refer to one or more representative examples, which may differ or overlap. Furthermore, terminology such as “comprising,” “including,” or “having” is intended to be inclusive and interchangeable in the context of this disclosure. Spatial descriptors like “top,” “bottom,” “above,” “below,” or “side” are employed merely for ease of explanation and are not meant to limit the disclosed concepts to a particular orientation. Drawings accompanying this disclosure are not necessarily to scale unless expressly stated. Where ordinal labels such as “first,” “second,” or “third” are used, they are intended only to distinguish between similar items and do not indicate any particular sequence or priority unless explicitly stated.

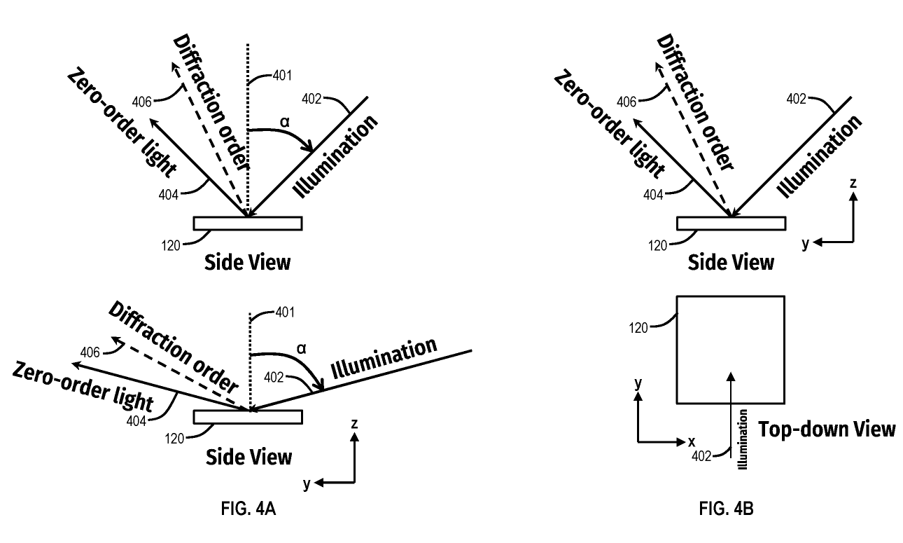

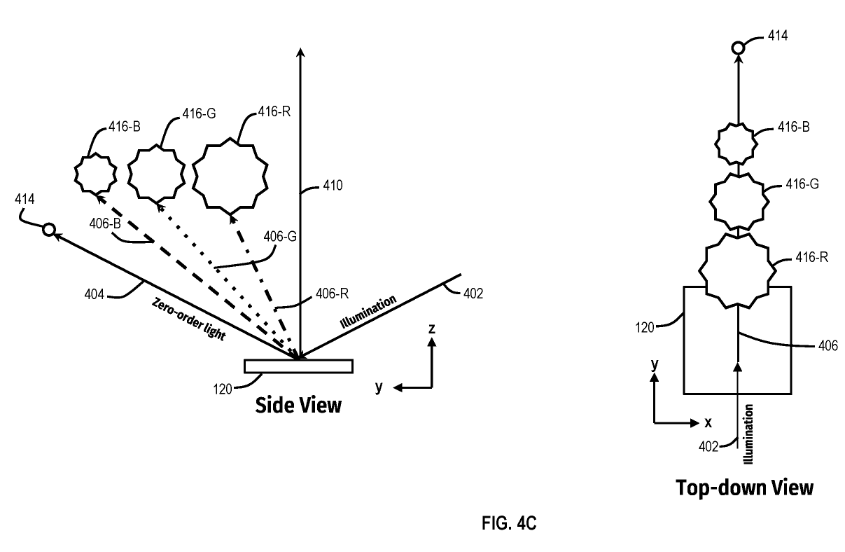

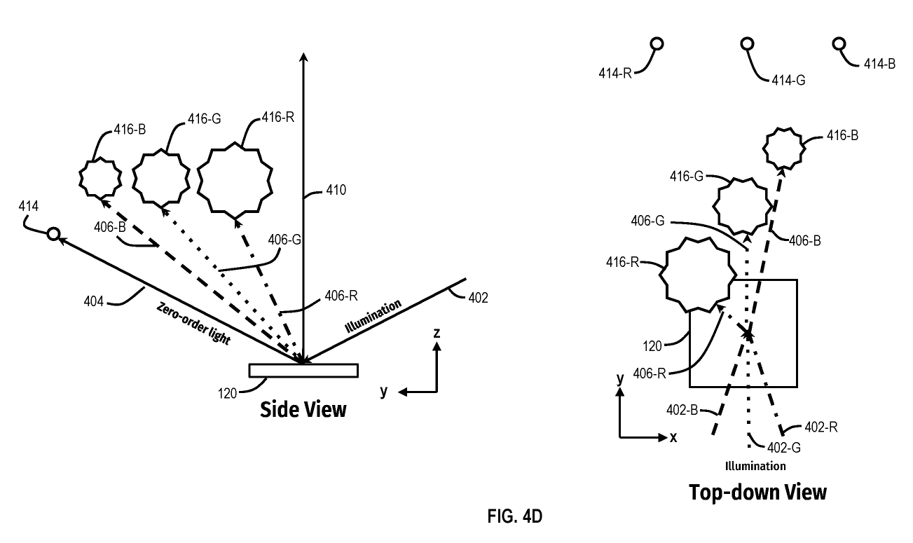

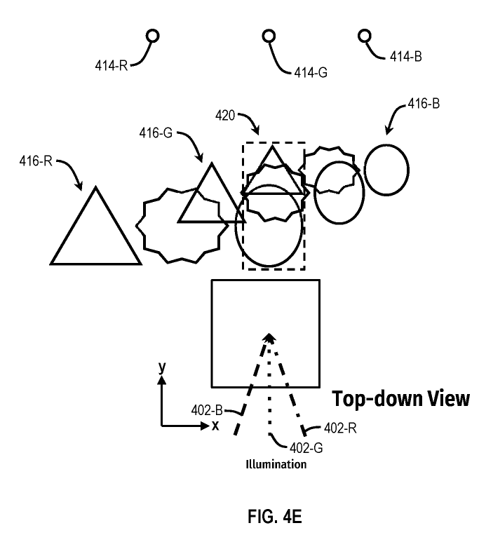

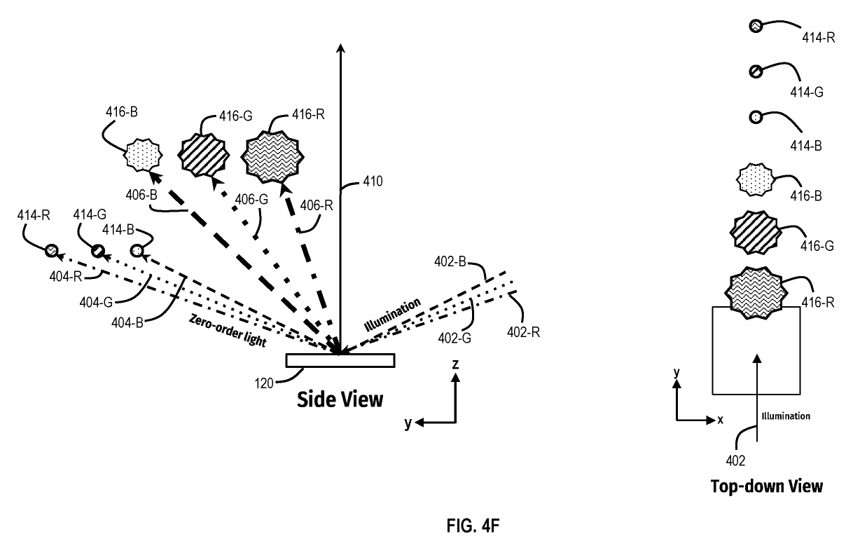

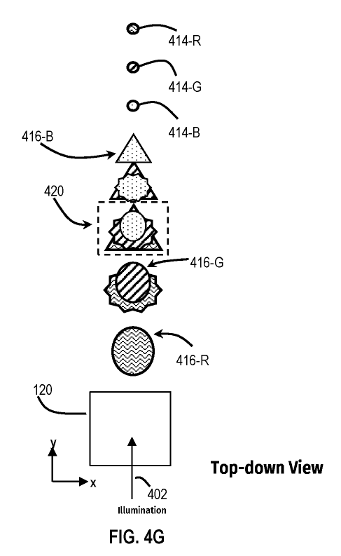

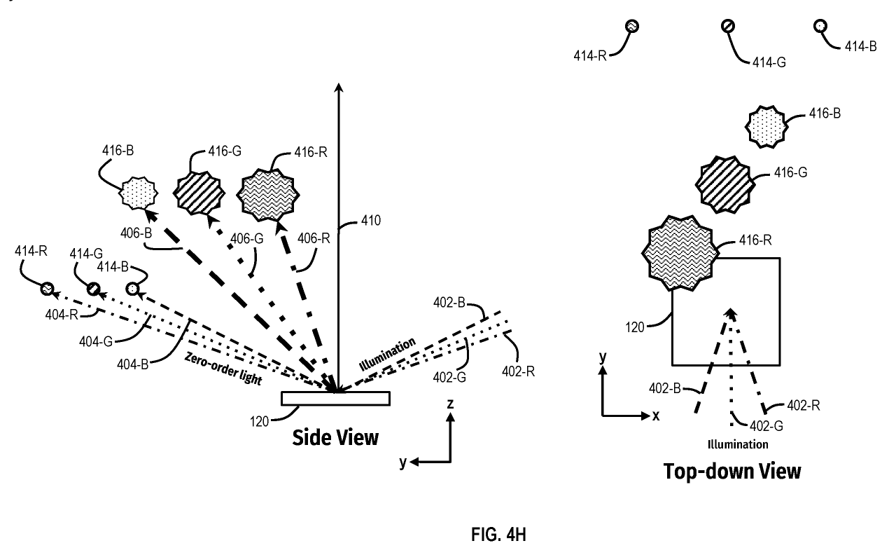

The detailed description references drawings that form an integral part of the disclosure and illustrate various embodiments. These are provided for explanatory purposes and do not limit the range of possible implementations. Variations may include structural or logical modifications while remaining within the scope of the invention. For the sake of clarity in the drawings, repetitive elements may not always be individually labeled. Groups of figures sharing the same number but differing by alphabetical suffixes may be referred to collectively without using the alphabetical suffixes (e.g., FIGS. 4A-4H may be referred to as “FIG. 4,” and so on).

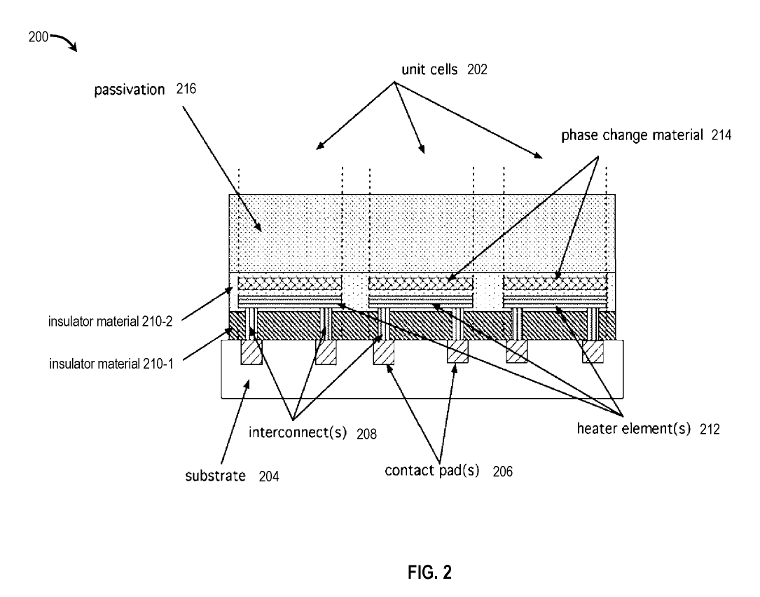

Some drawings may present schematic depictions of devices and assemblies (e.g., an array of light modulation elements shown in FIG. 2), using simplified geometry like straight lines and perfect angles. However, actual fabricated structures may exhibit deviations due to process limitations and defects visible in imaging techniques such as scanning electron microscopy (SEM) or transmission electron microscopy (TEM). These real-world images may reveal imperfections such as irregular edges, tapered vias, rounding of corners, non-uniform thicknesses, and crystalline dislocations, whether at the atomic scale or involving clusters of atoms. Other fabrication-related defects not listed here may also appear and are considered typical within the field. Techniques such as physical failure analysis (PFA), reverse engineering using microscopy, and inspection of layout or mask data may be used to confirm the presence of structures incorporating the light modulation elements without color filters, described herein.

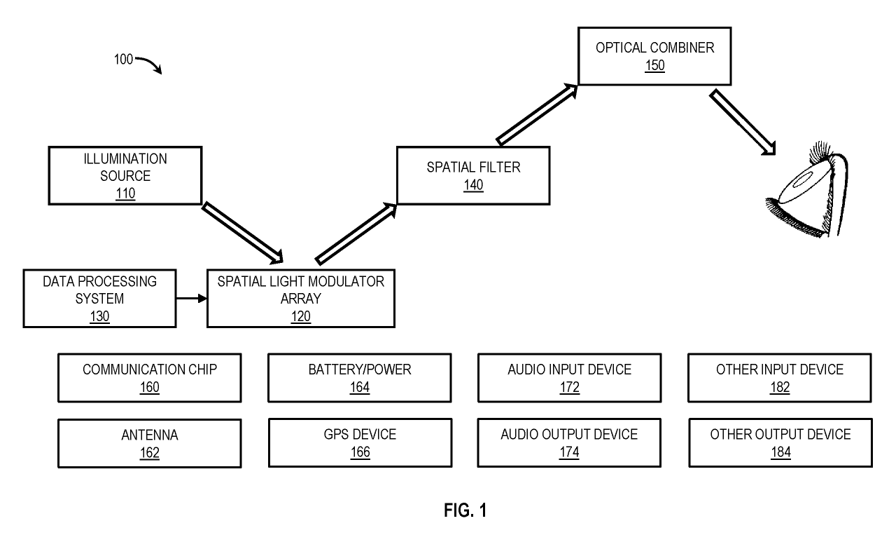

FIG. 1 provides a schematic illustration of a holographic display system 100, according to some embodiments. As shown in FIG. 1, the holographic display system 100 may provide an illumination source 110, an SLM array 120 (i.e., an array of light modulation elements), a data processing system 130, as well as, optionally, a spatial filter 140 and/or an optical combiner 150. FIG. 1 also schematically illustrates an eye of an observer looking at a reconstructed image rendered by the holographic display system 100.

The illumination source 110 may include one or more components capable of emitting light (e.g., coherent or partially-coherent light) suitable for holographic image reconstruction. In particular, the illumination source 110 may be configured to emit light to be incident on the SLM array 120, which may then modulate the incident light to form the holographic reconstruction image. The illumination source 110 may include one or more lasers, laser diodes, or other light sources (e.g., coherent or partially coherent light sources) capable of producing light at discrete wavelengths, such as red, green, and blue, to enable multi-color holographic imaging. In some embodiments, the illumination source 110 may include individual light sources, each emitting a distinct wavelength - for example, one laser for red, another for green, and a third for blue. In alternative embodiments, the illumination source 110 may include a single multi-wavelength light source, e.g., a single multi-wavelength laser, to generate two or more of the wavelengths (e.g., red and green), while additional light sources may be used in case additional wavelengths are desired.

As indicated in FIG. 1, the light beams emitted from the illumination source 110 are directed toward the SLM array 120. The illumination source 110 may further incorporate beam-steering or beam-directing components to control the angle at which each wavelength of light impinges on the SLM array 120. These components may include, but are not limited to, mirrors (e.g., MEMS-based mirrors or dichroic mirrors), optical prisms (e.g., x-cubes), diffraction gratings, holographic optical elements, volume holograms, metasurfaces, acousto-optic or electro-optic deflectors, or adjustable optical fibers, which can precisely alter the incident angles of the light beams.

The SLM array 120 may include an array of light modulation elements, such as SLM pixels, configured to dynamically encode the holographic patterns received from the data processing system 130. The SLM array 120 is configured to modulate the amplitude and/or phase (and/or the polarization) of the incident light beams provided by the illumination source 110 to create a diffracted wavefront corresponding to the hologram pattern provided by the data processing system 130. This wavefront carries the information necessary to reconstruct the target image. One example of the SLM array 120 is shown in FIG. 2; however, in other embodiments, any suitable SLM array may be used in accordance with the descriptions provided herein.

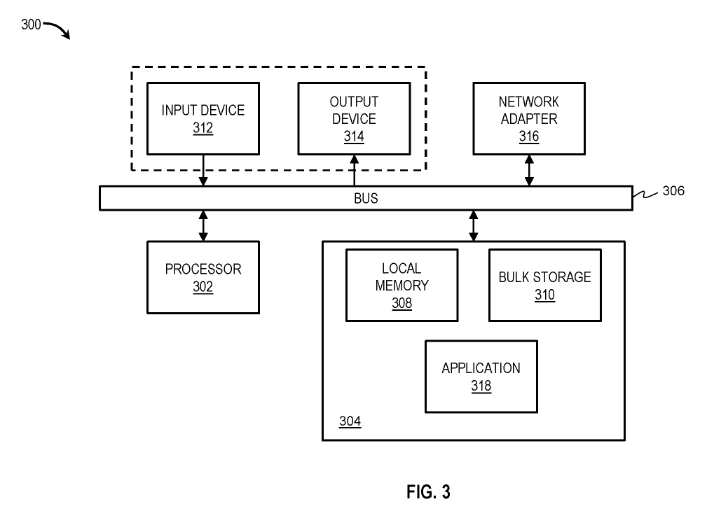

The data processing system 130 may be operatively coupled to the SLM array 120. The data processing system 130 may be configured to receive hologram patterns or to generate hologram patterns based on input data, such as a target image. These patterns may be computed using algorithms that account for the wavelengths emitted by the illumination source 110 and for the angles at which these light beams are incident onto the SLM array 120. The data processing system 130 may be configured to ensure that the hologram patterns are optimized for accurate reconstruction of the target image when the light beams from the illumination source 110 interact with the SLM array 120. One example of the data processing system 130 is shown in FIG. 3; however, in other embodiments, any suitable computing device may be used in accordance with the descriptions provided herein.

In some embodiments, a spatial filter 140 may be positioned downstream of the SLM array 120. The spatial filter 140 may be configured to selectively block unwanted light components output by the SLM array 120, such as zero-order light, conjugate images, and/or quantization noise, while allowing the desired diffracted light output by the SLM array 120 to pass through. As used herein, the term “zero-order” light refers to the zero-order diffraction of the light incident onto an SLM, which is typically light reflected from the SLM. Zero-order light may also be referred to as undiffracted light in some cases.

In various implementations, the spatial filter 140 may take the form of a physical aperture, or mask, or it may incorporate more advanced optical elements. In an implementation where the holographic display system 100 includes a 4f optical system, the spatial filter 140 can be located in front, at, or behind the Fourier plane of the 4f optical system. In other embodiments of the holographic display system 100, however, the spatial filter 140 may be omitted entirely. For example, the holographic display system 100 may be optically engineered to mitigate the impact of undesired light without needing a dedicated spatial filter. This may be accomplished by limiting the field of view (FoV) collected by the downstream optical system, such as through careful design of lens apertures or acceptance angles, so that only the intended diffracted orders fall within the system's collection angle, while stray or undesired components fall outside of it. In such cases, the absence of a spatial filter may simplify the system architecture while still achieving acceptable image quality for the intended application.

In some embodiments, the holographic display system 100 may include an optical combiner 150 configured to receive the light as modulated by the SLM array 120, possibly after said light has been filtered by the spatial filter 140, and to overlay the reconstructed color image with a view of the physical environment. The optical combiner 150 may include one or more optical components, including but not limited to lenses, beam splitters, partially reflective mirrors, prisms, diffraction gratings, volume holograms, holographic optical elements, metasurfaces (e.g., 2D artificial sheet materials with subwavelength features that can manipulate light), or other light-directing elements. The output from the optical combiner 150 may then be directed toward the observer's eye, enabling visual perception of the reconstructed holographic scene.

In some implementations, the optical combiner 150 may be particularly useful when the holographic display system 100 is integrated into an augmented reality (AR) platform. In such cases, the combiner 150 may be designed as a partially reflective optical element (e.g., a see-through combiner in the form of a holographic optical element) that overlays the reconstructed virtual image onto the user’s direct view of the physical environment. This allows the virtual content to be seamlessly superimposed on the real-world scene that the observer is looking at, providing a spatially registered and contextually integrated AR experience.

In other embodiments, the optical combiner 150 may be omitted, particularly in systems where full immersion is desired. For example, if the holographic display system 100 is part of a virtual reality (VR) system, there may be no need to optically combine virtual and real-world views, as the entire visual field presented to the observer is synthetic. In such cases, the system may instead employ enclosed optics or dedicated display paths that directly route the reconstructed holographic imagery to each eye without requiring transparency or real-world overlay capabilities. This simplification may reduce system complexity and increase light efficiency, which may be especially advantageous in head-mounted display (HMD) configurations.

In some embodiments, the holographic display system 100 may include, or may be communicatively coupled to, one or more of a communication chip 160, an antenna 162, a battery/power circuitry 164, a global positioning system (GPS) device 166, an audio input device 172, an audio output device 174, an other input device 182, or an other output device 184.

The communication chip 160 may be configured for managing wireless communications for the transfer of data to and from the holographic display system 100. The term "wireless" and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 160 may implement any of a number of wireless standards or protocols, including but not limited to Institute for Electrical and Electronic Engineers (IEEE) standards, including Wi-Fi (IEEE 802.11 family), IEEE 802.16 standards (e.g., IEEE 802.16-2005 Amendment), Long-Term Evolution (LTE) project, along with any amendments, updates, and/or revisions (e.g., advanced LTE project, ultra-mobile broadband (UMB) project (also referred to as "3GPP2"), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 160 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 160 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 160 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 160 may operate in accordance with other wireless protocols in other embodiments. The holographic display system 100 may include an antenna 162 to facilitate wireless communications and/or to receive other wireless communications (such as AM or FM radio transmissions).

In some embodiments, the communication chip 160 may manage wired communications, such as electrical, optical, or any other suitable communication protocols (e.g., Ethernet). In some embodiments, the communication chip 160 may include multiple communication chips. For instance, a first communication chip 160 may be dedicated to shorter-range wireless communications, such as Wi-Fi or Bluetooth, and a second communication chip 160 may be dedicated to longer-range wireless communications, such as global positioning system (GPS), EDGE, GPRS, CDMA, WiMAX, LTE, EV-DO, or others. In some embodiments, a first communication chip 160 may be dedicated to wireless communications, and a second communication chip 160 may be dedicated to wired communications.

In some embodiments, the holographic display system 100 may include a battery/power circuitry 164. The battery/power circuitry 164 may include one or more energy storage devices (e.g., batteries or capacitors) and/or circuitry for coupling components of the holographic display system 100 to an energy source separate from the holographic display system 100 (e.g., AC line power).

In some embodiments, the holographic display system 100 may include a GPS device 166 (or corresponding interface circuitry, as discussed above). The GPS device 166 may be in communication with a satellite-based system and may receive a location of the holographic display system 100, as known in the art.

In some embodiments, the holographic display system 100 may include an audio input device 172 (or a corresponding interface to be connected to said circuitry). The audio input device 172 may include any device that generates a signal representative of a sound, such as microphones, microphone arrays, or digital instruments (e.g., instruments having a musical instrument digital interface (MIDI) output).

In some embodiments, the holographic display system 100 may include an audio output device 174 (or a corresponding interface to be connected to said circuitry). The audio output device 174 may include any device that generates an audible indicator, such as speakers, headsets, or earbuds.

In some embodiments, the holographic display system 100 may include an other input device 182 (or a corresponding interface to be connected to said circuitry). Examples of the other input device 182 may include an eye-tracking device, a camera or another image capture device, an accelerometer, a gyroscope, a compass, a keyboard, a cursor control device, such as a mouse, a stylus, a touchpad, a bar code reader, a Quick Response (QR) code reader, any sensor, or a radio frequency identification (RFID) reader.

In some embodiments, the holographic display system 100 may include an other output device 184 (or corresponding interface circuitry, as discussed above). Examples of the other output device 184 may include an audio codec, a video codec, a printer, a wired or wireless transmitter for providing information to other devices, or an additional storage device.

The holographic display system 100 may be designed to project high-quality holographically-generated images without the use of color filters, leveraging the angular separation of light beams of different wavelengths and advanced computational techniques for generating holograms, as described herein. This configuration may eliminate or alleviate challenges associated with conventional color filter-based systems, such as reduced resolution, blurred images due to extended PSFs, optical inefficiencies as the color filters block or attenuate some of the light, and color artifacts arising from non-uniform filter performance, while also simplifying the overall system architecture. This configuration may further eliminate or reduce challenges associated with using multiple SLMs, such as increased system complexity, higher power consumption, bulkier hardware footprint, and more demanding optical alignment requirements. Additionally, it may address limitations inherent to sequential illumination of a single SLM, such as reduced effective frame rate, temporal color breakup (flicker), and increased latency (the latter may be particularly problematic in dynamic or interactive display scenarios). By circumventing these issues, the described configuration enables a more compact, efficient, and visually compelling holographic display system suitable for a broad range of applications.

The holographic display system 100 may be implemented in any suitable form factor, depending on the intended application and user experience. For example, the system may take the form of wearable devices such as AR glasses, mixed reality headsets, VR goggles, or smartwatches. These wearable implementations are particularly well-suited for immersive applications where hands-free operation, mobility, and user comfort are important. Alternatively, the system may be integrated into stationary platforms such as desktop monitors, heads-up displays (HUDs), or windshields for automotive or avionics for use in navigation, training simulations, or professional visualization tasks. In some embodiments, the holographic display system 100 may also be embedded in portable devices like tablets or smartphones, enabling compact and mobile holographic interaction. The specific form factor may influence the design of various components of the system, including the size and layout of the SLM array 120, the configuration of the optical components, power management systems, and the computing architecture used for hologram generation and display.

FIG. 2 provides a cross-sectional side view of an example SLM array 200, according to some embodiments. The SLM array 200 may be one example of the SLM array 120 of FIG. 1. In various examples, light modulation can be described as a process for controlling one or more properties of light, such as amplitude, phase, polarization, or frequency. In an example, a light modulation process can be a static process. In another example, a light modulation process can be a dynamic process. In further examples of implementation and operation, light modulation can include spatial light modulation, where spatial light modulation can be described as a process for changing the spatial distribution of the amplitude, phase, and/or polarization of one or more optical light waves. In another example, spatial light modulation can be described as a process for changing the spatial distribution of the amplitude, phase, and/or polarization of an electro-magnetic field. In an example, an SLM can be a two-dimensional array of pixels that can be used to dynamically modulate light in space and time. In various examples, spatial light modulation can be achieved by altering the phase, amplitude, polarization, or any combination thereof of light. In a specific example, an array of tunable pixels can be used to diffract an incoming light beam, enabling the interference of light waves in 3D space. In a related example, an incoming light beam spectrum can be selected such that a projected rendering is substantially within the visible spectrum (wavelength range of 400 – 700 nm) for observation by humans.

In an example, unit cells 202 may be formed as stacks on a substrate 204, together forming an SLM array 200. Accordingly, a unit cell array can refer to an array of light modulation elements, a light modulation array, or a pixel array. In some embodiments, substrate 204 can be an IC fabricated through, e.g., front-end-of-line (FEOL) processes to form various CMOS elements, interconnects, logic structures, and control structures. In a more specific example, substrate 204 may be fabricated to provide elements configured for electrical connections, such as contact pads 206 for connection to unit cells 202. In an alternative example, contact pads 206 may be formed on substrate 204 as one or more process steps used in the formation of unit cells 202. In an example, contact pads 206 may be adapted to electrically couple substrate 204 to each of the unit cells 202. In yet another example, substrate 204 can include CMOS back-end-of-line (BEOL) elements configured to provide electrical interconnections for CMOS elements and electrical connections to unit cells 202.

In some embodiments, electrical interconnects 208 may be formed on substrate 204 to provide electrical connections between various elements of substrate 204 and elements of unit cells 202. In some embodiments, interconnects 208 may be formed of one or more electrically conductive materials separated by one or more insulating materials (dielectrics), the one or more insulating materials comprising at least a portion of insulator material 210-1, to provide thermal separation and/or electrical isolation between individual elements of unit cells 202 and to provide electrical isolation between electrical interconnects 208. In various examples, each interconnect of interconnects 208 may be adapted to provide an electrical connection at a first end between a contact pad of the contact pads 206 and another element of a unit cell of unit cells 202 at a second end. In an example, insulator material 210-1 is configured to provide electrical isolation between some or all of interconnects 208. Example insulator materials described herein, e.g., any of the insulator material 210-1 or the insulator material 210-2, may include materials such as silicon dioxide, silicon nitride, silicon oxynitride, silicon oxycarbide nitride, or low-k dielectric materials (e.g., materials having a dielectric constant lower than that of silicon). Low-k dielectric materials may include various organic and inorganic low-k materials, such as fluorinated silicon dioxide, organosilicate glass, and porous dielectric materials. Other examples of insulator materials described herein may include high-k dielectric materials (e.g., materials having a dielectric constant higher than that of silicon) that may be advantageous in terms of providing a reduced physical thickness of a given dielectric layer, with examples including hafnium oxide (HfO2), zirconium oxide (ZrO2), and aluminum oxide (Al2O3). Other examples of insulator materials that may be used in the SLM array 200 include organic polymers such as polyimides, borophosphosilicate glass (BPSG), and spin-on glass (SOG).

In an example, insulator material 210-1 can be deposited, patterned, and etched using various photolithography methodologies to provide voids for the formation of interconnects 208 in the voids. In an example, insulator material 210-1 can be provided with voids for the formation of interconnects 208 by depositing conductive materials over insulator material 210-1, such that the conductive material forms a plurality of conducting structures between substrate 204 and other elements of unit cells 202. Example conductive materials include one or more of aluminum, copper alloy, or any other reasonably efficient electrical conductor, but need not comprise a metal material. In a related example, conducting materials can be at least partially removed (using, for example, a planarization process and/or a patterning and etching process) to form interconnects 208 to enable coupling to other elements of unit cells 202. In some embodiments, interconnects 208 can be formed in a plurality of steps, with each interconnect of interconnects 208 comprising additional elements (not shown in the present drawings). In the various examples, the additional elements can be formed using multiple photolithographic operations to provide routing and connectivity between contact pads 206 and various elements of the unit cells 202.

In some embodiments, substrate 204 may include processing circuitry for controlling an electric potential and current flow through each interconnect of interconnects 208, such that arrangements of one or more of the interconnects that comprise interconnects 208 can be controlled independently. In some embodiments, a heater material can be formed over a surface adapted to provide connectivity to at least some of the interconnects of interconnects 208. In the example, heater material can be deposited on the surface over interconnects 208, which can be exposed using one or more etching or planarization processes, enabling coupling for interconnects 208 with the heater material. In a related example, heater material can be patterned to isolate the heater material in each unit cell from adjacent unit cells in order to create heater elements 212, where each heater element of heater elements 212 is associated with a unit cell of unit cells 202. In an example of operation, the SLM array 200 can be adapted to provide substantially independent application of current to each heater element of heater elements 212. In an example of operation, heater elements 212 are configured to receive electrical energy via the plurality of interconnects 208 to thereby induce Joule heating in the heater material. Example heater materials include tantalum nitride (TaN), electrically conductive metal oxide materials, or any other material with suitable electrical resistivity. In an example, the stoichiometry of TaN (the ratio of tantalum atoms to nitrogen atoms) can be adjusted to achieve a desired electrical resistance for the heater, while optimizing current and voltage applied to the heater element. In a specific related example, an additional factor defining the heater resistance can be TaN film thickness. In an example, by varying TaN stoichiometry and film thickness, the resistance of a heater element can be adjusted in a range of 1 Ohm – 1000 Ohm.

In some embodiments, various materials may be formed over the heater material used to form heater elements 212 in a completed unit cell stack for unit cells 202. In an example, each unit cell stack includes a phase-change material (PCM) 214 above the heater material comprising heater elements 212. In various examples, a PCM 214 may be a material having a reversible crystal phase property.

In some embodiments, a phase-change material, such as the PCM 214, can be adapted to thermally interconvert between one or more crystalline and one or more amorphous states on a relatively short time scale using, for example, a temperature pulse from a heat source. In an example, when changing the PCM 214 between amorphous and crystalline states, the refractive index of PCM 214 is changed, so that the amplitude and/or phase of the reflected light can be changed. In an example, once a pulse of temperature concludes, the state of PCM 214 is “locked-in” and remains unchanged absent another thermal interconversion event. In various examples, PCM 214 can be deposited as a thin film atop a dielectric material configured from insulator material 210-2. In some embodiments, deposition techniques for depositing the PCM 214 can include, for example, physical vapor deposition (PVD) with the phase-change material being evaporated from a solid source and then condensed onto the substrate. In other embodiments, the PCM 214 can be deposited using chemical vapor deposition (CVD) with a chemical reaction of gaseous precursors used to form a thin film phase-change material on the surface of insulator material 210-2. Example PCMs include, but are not limited to, GexSbyTez (Germanium Antimony Tellurium), SbxSy (Antimony Sulfide), SbxSey (Antimony Selenide), and MoxOy (Molybdenum Oxide).

In some embodiments, the insulator material 210-2 may include one or more materials to provide mechanical, electrical, or chemical protection for the PCM 214. In some embodiments, the insulator material 210-2 may be configured as an anti-diffusion material for the PCM 214. In some embodiments, a passivation 216 may be adapted to provide mechanical and/or electrical protection for unit cells 202. In an additional example, the passivation 216 can comprise one or more materials having relatively high thermal insulating properties, including, but not limited to, silicon oxide or titanium oxide.

In some embodiments, the PCM of a unit cell, such as the PCM 214, may be configured to be changeable between two states. In an example, the two states can be a substantially crystalline state as a first state and a substantially amorphous state as a second state. In an alternative example, the PCM of a unit cell may be configured to be changeable between more than two states: a substantially crystalline state, a substantially amorphous state, and one or more additional states between the substantially crystalline state and the substantially amorphous state. As an example, a state being defined as being between a substantially crystalline state and a substantially amorphous state can indicate formation and growth/expansion of one or more crystalline nucleation sites within an amorphous state. In another example, a substantially crystalline state indicates that one or more crystalline nucleation sites have enlarged sufficiently that no more amorphous state remains. In a specific example, multiple states between a substantially crystalline state and a substantially amorphous state can be achieved in practice by intentionally stopping the growth of the one or more crystalline nucleation sites at each of multiple growth stages.

FIG. 3 is a schematic illustration of an example data processing system 300 configured to control operation of a holographic display system, according to some embodiments. For example, the data processing system 300 may be configured to implement or control portions of the holographic display system 100. The data processing system 300 may be one example of the data processing system 130 of FIG. 1. In some embodiments, the data processing system 300 may be configured to generate holograms to be used with a single array of light modulation elements without color filters operable with wavelength-multiplexed illumination (e.g., with the SLM array 120 or with the SLM array 200), according to some embodiments.

As shown in FIG. 3, the data processing system 300 may include at least one processor 302, e.g., a hardware processor 302, coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computing system that is suitable for storing and/or executing program code. It should be appreciated, however, that the data processing system 300 may be implemented in the form of any system including a processor and a memory that is capable of performing the functions described within this disclosure.

In some embodiments, the processor 302 can execute software or an algorithm to perform the activities as discussed in the present disclosure, in particular activities related to generating holograms for performing color holography using a single array of light modulation elements without color filters operable with wavelength-multiplexed illumination, as described herein. The processor 302 may include any combination of hardware, software, or firmware providing programmable logic, including by way of non-limiting example a microprocessor, a digital signal processor (DSP), a field-programmable gate array (FPGA), a programmable logic array (PLA), an application-specific IC (ASIC), or a virtual machine processor. The processor 302 may be communicatively coupled to the memory elements 304, for example in a direct-memory access (DMA) configuration, so that the processor 302 may read from or write to the memory elements 304.

In general, the memory elements 304 may include any suitable volatile or non-volatile memory technology, including double data rate (DDR) random-access memory (RAM), synchronous RAM (SRAM), dynamic RAM (DRAM), flash, read-only memory (ROM), optical media, virtual memory regions, magnetic or tape memory, or any other suitable technology. Unless specified otherwise, any of the memory elements discussed herein should be construed as being encompassed within the broad term "memory." The information being measured, processed, tracked, or sent to or from any of the components of the data processing system 300 could be provided in any database, register, control list, cache, or storage structure, all of which can be referenced at any suitable timeframe. Any such storage options may be included within the broad term "memory" as used herein. Similarly, any of the potential processing elements, modules, and machines described herein should be construed as being encompassed within the broad term "processor." Each of the elements shown in the present figures, e.g., any elements of the holographic display system 100 (e.g., the SLM array 120, the communication chip 160, the antenna 162, etc.), can also include suitable interfaces for receiving, transmitting, and/or otherwise communicating data or information in a network environment so that they can communicate with, e.g., the data processing system 300.

In certain example implementations, mechanisms for realizing color holography using a single array of light modulation elements without color filters operable with wavelength-multiplexed illumination as outlined herein may be implemented by logic encoded in one or more tangible media, which may be inclusive of non-transitory media, e.g., embedded logic provided in an application-specific integrated circuit (ASIC), in digital signal processing (DSP) instructions, software (potentially inclusive of object code and source code) to be executed by a processor, or other similar machine, etc. In some of these instances, memory elements, such as the memory elements 304 shown in FIG. 3, can store data or information used for the operations described herein. This includes the memory elements being able to store software, logic, code, or processor instructions that are executed to carry out the activities described herein. A processor can execute any type of instructions associated with the data or information to achieve the operations detailed herein. In one example, the processors, such as the processor 302 shown in FIG. 3, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field-programmable gate array (FPGA), a DSP, an erasable programmable read-only memory (EPROM), an electrically erasable programmable read-only memory (EEPROM)) or an ASIC that includes digital logic, software, code, electronic instructions, or any suitable combination thereof.

The memory elements 304 may include one or more physical memory devices such as, for example, local memory 308 and one or more bulk storage devices 310. The local memory may refer to RAM or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution.

As shown in FIG. 3, the memory elements 304 may store an application 318. In various embodiments, the application 318 may be stored in the local memory 308, the one or more bulk storage devices 310, or apart from the local memory and the bulk storage devices. It should be appreciated that the data processing system 300 may further execute an operating system (not shown in FIG. 3) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Input/output (I/O) devices depicted in FIG. 3 as an input device 312 and an output device 314, optionally, can be coupled to or included in the data processing system 300. Examples of input devices 312 may include, but are not limited to, an image capture device, an eye-tracking device, a keyboard, a pointing device such as a mouse, or the like. Examples of output devices 314 may include, but are not limited to, a monitor or a display, speakers, or the like. In some embodiments, the output device 314 may be any type of screen display, such as a spatial light modulator (SLM), plasma display, LCD, organic light-emitting diode (OLED) display, electroluminescent (EL) display, or any other indicator, such as a dial, barometer, or LEDs. In some implementations, the system may include a driver (not shown) for the output device 314. Input devices 312 and/or output devices 314 may be coupled to the data processing system either directly or through intervening I/O controllers.

In an embodiment, the input and the output devices may be implemented as a combined input/output device (illustrated in FIG. 3 with a dashed line surrounding the input device 312 and the output device 314). An example of such a combined device is a touch-sensitive display, also sometimes referred to as a “touch screen display” or simply “touch screen”. In such an embodiment, input to the device may be provided by a movement of a physical object, such as a stylus or a finger of a user, on or near the touch screen display.

A network adapter 316 may also, optionally, be coupled to the data processing system 300 to enable it to become coupled to other systems, computer systems, remote network devices, and/or remote storage devices through intervening private or public networks. The network adapter may comprise a data receiver for receiving data that is transmitted by said systems, devices, and/or networks to the data processing system 300, and a data transmitter for transmitting data from the data processing system 300 to said systems, devices, and/or networks. Modems, cable modems, and Ethernet cards are examples of different types of network adapters that may be used with the data processing system 300.

FIGS. 4A-4H illustrate a basic framework behind performing color holography using a single array of light modulation elements without color filters and without using sequential illumination, the array being operable with wavelength-multiplexed illumination, according to some embodiments.

FIG. 4A illustrates the relation between illumination 402 (e.g., laser illumination as provided by the illumination source 110), zero-order light 404, and a diffraction order 406 (e.g., first-order diffracted light) in a holographic display system. In particular, FIG. 4A illustrates two cross-sectional side views of an SLM array 120, which differ in the angles of the illumination 402, and, correspondingly, the angles of the zero-order light 404 and the diffraction order 406. The zero-order light 404, which is the mirror reflection of the illumination 402 from the illumination source 110, serves as an undiffracted portion of the incident laser beam. The zero-order light 404 acts as an "anchor," positioning the reconstructed image in the correct location within the FoV. The angular separation between the zero-order light 404 and the diffraction order 406 is determined by the wavelength of the illumination 402 and the pixel pitch of the SLM and/or the holographic pattern applied to the SLM array 120, and, in some embodiments, can be referred to as a “diffraction angle.” This angular separation ensures that the reconstructed image is spatially distinct from the undiffracted beam. The angular position of the reconstructed image is determined by the illumination angle of the illumination 402, among other factors. If the SLM array 120 is illuminated at an angle α close to 45 degrees, the reconstructed image appears at a location along the line illustrating the diffraction order 406 in the upper side view shown in FIG. 4A (examples of how diffraction order light produces reconstructed images are shown in some of the subsequent drawings, e.g., in FIGS. 4C, 4D, 4F, and 4H). As shown in FIG. 4A, the angle α is defined as an angle between a normal 401 (dotted line) to the SLM array 120 and the illumination 402. Conversely, if the illumination angle α is closer to 60 degrees, the reconstructed image shifts because it still appears at a location along the line illustrating the diffraction order 406 but that line has shifted, as shown in the lower side view shown in FIG. 4A. In both cases, the structure of the hologram programmed on the SLM array 120 remains unchanged, but the illumination angle directly influences the positioning of the diffraction order 406 (e.g., first-order diffracted light) relative to the normal 401 to the SLM array 120, thereby determining where the image resides in angular space. The diffraction orders (e.g., the diffraction order 406), which emerge from the SLM array 120 after interacting with the hologram pattern, can carry the amplitude and/or phase information necessary to reconstruct the target image. The illumination, incident at specific angles, interacts with the hologram pattern, which results in these diffraction orders (e.g., the diffraction order 406), enabling precise control over the spatial positioning of the reconstructed image. FIG. 4A highlights the critical role of illumination angles in determining the angular placement of holographically-generated images.

FIG. 4B builds upon the concepts introduced in FIG. 4A, illustrating the interaction between illumination, zero-order light, and diffraction order in a holographic display system, but with a focus on a one-dimensional (1D) off-axis illumination configuration. FIG. 4B provides two perspectives: a side view of the SLM array 120 (upper view shown in FIG. 4B) and a top-down view of the SLM array 120 (lower view shown in FIG. 4B), which together demonstrate how the angular positioning of the illuminating beam influences the spatial arrangement of the reconstructed image (which is present at a location along the line illustrating the diffraction order 406). The side view of FIG. 4B is the same as the upper side view shown in FIG. 4A. The top-down view of FIG. 4B is a top-down view corresponding to the side view of FIG. 4B, with the illumination 402 shown in the top-down view of FIG. 4B representing a projection of the illumination 402 onto a plane of, or parallel to, the SLM array 120 (analogous applies to the top-down views shown in FIGS. 4C-4H). Together, the side view and the top-down view illustrate how the illumination angle and hologram pattern work in tandem to precisely control the spatial positioning of the reconstructed image in angular space, highlighting the importance of beam alignment and hologram design in achieving high-quality holographic displays. The illumination configuration shown in FIG. 4B may be referred to as “1D off-axis” because the angle between the illumination 402 and the z-axis (i.e., the normal to the SLM array 120) is greater than zero, while the illumination 402 is in a plane parallel to the x-z plane or in a plane parallel to the y-z plane. In contrast, an illumination configuration may be referred to as “2D off-axis” when the angle between the illumination 402 and the z-axis (i.e., the normal to the SLM array 120) is greater than zero, and the illumination 402 is not in a plane parallel to the x-z plane and not in a plane parallel to the y-z plane, such that the angle between the illumination 402 and the projection of the illumination 402 onto a plane parallel to the x-z plane or to the y-z plane is greater than zero. For example, in FIGS. 4D, 4E. or 4H, illumination 402-G is 1D off-axis, while illumination 402-B or 402-R is 2D off-axis.

FIG. 4C further expands on the principles illustrated in FIGS. 4A and 4B, demonstrating the relation between laser illumination, zero-order light, and diffraction orders in a holographic display system when three wavelengths (e.g., red, green, and blue) are used simultaneously in a 1D off-axis illumination configuration. FIG. 4C provides two perspectives: a side view (left) and a top-down view (right), which together illustrate how the angular positioning of the illuminating beams and the differences in wavelength influence the spatial arrangement and scaling of the reconstructed images.

The illumination 402 in the example shown in FIG. 4C includes light of three wavelengths, all three light beams incident on the SLM array 120 along the same direction, where, as used herein, the term “direction” of a light beam refers to the direction of the beam in the 3D space. As in FIGS. 4A and 4B, the zero-order light 404, which is the mirror reflection of the illumination 402, serves as an undiffracted portion of the incident light beams and acts as an "anchor" that positions the reconstructed images in the correct location within the FoV. Because the directions of the illumination beams of the three wavelengths of the illumination 402 are the same, the direction of the zero-order light 404 is also the same for the three wavelengths. As a result, zero-order images 414 for the three wavelengths overlap. On the other hand, because diffraction orders depend on the wavelength, the directions of the diffracted orders 406 for different wavelengths will be different, as shown in the side view of FIG. 4C, where a dash-dotted line illustrates a diffraction order 406-R for the diffracted red light of the illumination 402, a dotted line illustrates a diffraction order 406-G for the diffracted green light of the illumination 402, and a dashed line illustrates a diffraction order 406-B for the diffracted blue light of the illumination 402. In particular, the top-down and the side views of FIG. 4C illustrate that the directions of the diffracted orders 406-R, 406-G, and 406-B are in a single plane perpendicular to the plane of the SLM array 120 (e.g., in a single y-z plane). However, the directions of the diffracted orders 406-R, 406-G, and 406-B are different from one another because the angles between a line perpendicular to the SLM array 120 (shown in FIG. 4C and some of the subsequent drawings as a normal 410) and different ones of the diffracted orders 406-R, 406-G, and 406-B are different from one another. As a result of the wavelength-dependent diffraction order direction, reconstructed images 416 (individually labeled in FIG. 4C as a reconstructed image 416-R for the red light, a reconstructed image 416-G for the green light, and a reconstructed image 416-B for the blue light) of the same target image will be at different locations along the y-axis of the example coordinate system shown. It should be noted that FIGS. 4C-4H are schematic representations intended to illustrate reconstructed images that may be observable across the entire field-of-view (FoV) generated by the SLM array (e.g., SLM array 120). Most of the embodiments of this disclosure make use of red, green, and blue light in order to explain the invention; however, it should be noted that the disclosure is not limited to these three wavelengths only, and that the disclosure can work for any combination of two or more wavelengths.

Furthermore, the scale/size of the reconstructed images 416 is different for different wavelengths, as shown in FIG. 4C, illustrating that the size of the reconstructed images 416 varies due to the differences in wavelength. Specifically, the blue diffraction order 406-B produces the smallest reconstructed image 416-B, the red diffraction order 406-R produces the largest reconstructed image 416-R, and the green diffraction order 406-G produces a reconstructed image 416-G that has a size that falls in between the size of the blue reconstructed image 416-B and of the red reconstructed image 416-R. This variation in scale arises because the diffraction angle is directly proportional to the wavelength of the incident light, meaning shorter wavelengths (e.g., blue) result in smaller diffraction angles and smaller reconstructed images, while longer wavelengths (e.g., red) result in larger diffraction angles and larger reconstructed images. In other words, the variation in size of the reconstructed image for each color arises because the diffraction angles scale with the wavelength.

The side view shown in FIG. 4C illustrates the angular separation of the zero-order light 404 and the diffraction orders 406 for each wavelength (e.g., first-order diffracted light for each wavelength), showing how the reconstructed images for red, green, and blue are spatially distributed. The top-down view shown in FIG. 4C complements this by providing a planar perspective of the spatial arrangement of the reconstructed images relative to the zero-order light 404. Together, these views highlight the importance of wavelength-dependent scaling in holographic image reconstruction and demonstrate how the hologram pattern and illumination angles can be designed to achieve precise alignment and scaling of the reconstructed images for different colors.

For the example shown in FIG. 4C, the direction of the illumination of the three wavelengths of the illumination 402 is the same, as can be seen by analyzing the angles of incidence (on the SLM array 120) of the illumination 402 in the side view and the top-down view of FIG. 4C. In particular, both the side view and the top-down view of FIG. 4C illustrate only one beam of the illumination 402, representing the light beam for all three wavelengths. This means that, in the illustration of FIG. 4C, projections of portions of the illumination 402 at different wavelengths onto a plane of, or parallel to, the SLM array 120 (i.e., projections shown in the top-down view of FIG. 4C) overlap with one another. FIG. 4D illustrates a scenario similar to that of FIG. 4C, except that the directions of the three wavelengths of the illumination 402 are not the same. In particular, in the embodiment of FIG. 4D, the directions of the three wavelengths of the illumination 402 are not the same because projections of portions of the illumination 402 of different wavelengths onto a plane of the SLM array 120 do not overlap with one another. This may be seen in the top-down view of FIG. 4D, illustrating three beams of the illumination 402 for three different wavelengths, individually labeled in FIG. 4D as illumination 402-B for the blue light, illumination 402-G for the green light, and illumination 402-R for the red light, which represent projections of the illumination 402 onto a plane of the SLM array 120. As shown in the top-down view of FIG. 4D, projections of the illumination 402-B, the illumination 402-G, and the illumination 402-R onto the plane of the SLM array 120 are separated from one another by non-zero angles, which is different from the analogous view of FIG. 4C. What is similar to the embodiment of FIG. 4C is that, in the embodiment of FIG. 4D, for each of the illumination 402-B, the illumination 402-G, and the illumination 402-R, angles between the respective illumination 402 and the normal 410 are the same. This can be seen in the side view of FIG. 4D, showing only a single illumination 402, although it is understood that the illumination 402 shown in the side view of FIG. 4D is an illustration of one of the illumination 402-B, the illumination 402-G, and the illumination 402-R (e.g., of the illumination 402-G), with the illumination beams of the other two wavelengths being in different planes with respect to what is shown in the plane of the side view of FIG. 4D, in line with the top-down view of FIG. 4D. Analogous applies to the diffraction orders 406 shown in the side view of FIG. 4D: only one of the diffraction orders 406-B, 406-G, and 406-R is actually in the y-z plane shown in the side view of FIG. 4D (e.g., the diffraction order 406-G), while the diffraction orders of the other two wavelengths are in different planes with respect to what is shown in the plane of the side view of FIG. 4D, in line with the top-down view of FIG. 4D. Diffraction orders 406-R, 406-G, and 406-B, as shown in the present drawings, are directed toward only a portion of their respective replay field generated by the diffracted light, rather than necessarily toward a center of their respective replay field. The embodiment of FIG. 4D illustrates that changing, for different wavelengths, the direction of illumination around the normal 410 results in an offset of the zero-order images 414 for different wavelengths (individually labeled in the top-down view of FIG. 4D as a zero-order image 414-R for the red light, a zero-order image 414-G for the green light, and a zero-order image 414-B for the blue light), e.g., as can be seen in the top-down view of FIG. 4D. The embodiment of FIG. 4D further illustrates that changing the direction of illumination for different wavelengths around the normal 410 results in an offset of the reconstructed images 416 for different wavelengths away from the y-axis, as was the case for the embodiment of FIG. 4C, e.g., as can be seen in the top-down view of FIG. 4D.

As described above, the illumination 402 shown in the top-down views of FIGS. 4B-4D (as well as what is shown in FIGS. 4E-4H) represents projections of the illumination 402 onto a plane of the SLM array 120. This means that dashed, dotted, and dash-dotted lines of the illumination 402-B, the illumination 402-G, and the illumination 402-R shown in the top-down view of FIG. 4D represent planes that contain a normal to the SLM array 120 (e.g., the normal 410) and directions of the light beams of different wavelengths/colors. Thus, the dashed line shown in the top-down view of FIG. 4D represents a plane B comprising a normal to the SLM array 120 (i.e., a line perpendicular to the SLM array 120) and a direction of the illumination 402-B for the blue light, the dotted line shown in the top-down view of FIG. 4D represents a plane G comprising a normal to the SLM array 120 (i.e., a line perpendicular to the SLM array 120) and a direction of the illumination 402-G for the green light, and the dash-dotted line shown in the top-down view of FIG. 4D represents a plane R comprising a normal to the SLM array 120 (i.e., a line perpendicular to the SLM array 120) and a direction of the illumination 402-R for the red light. As can be seen in the top-down view of FIG. 4D, an angle between any pair of the planes B, G, and R is greater than 0 degrees, e.g., greater than 0 degrees and less than 180 degrees, or greater than 0 degrees and less than 90 degrees, or greater than 0 degrees and less than 40 degrees. This is in contrast to the illumination scenario of FIG. 4C, where analogous angles between any pair of the planes B, G, and R are each 0 degrees.

FIG. 4E illustrates a continuation of the principles demonstrated in FIGS. 4A-4D, focusing on the relation between laser illumination, zero-order light, and diffraction orders (e.g., first-order diffraction of the red, green, and blue illumination) in a holographic display system when three wavelengths (e.g., red, green, and blue) are used simultaneously. Specifically, FIG. 4E represents a scenario analogous to that shown in FIG. 4D, but with a larger target image, represented by a combination of geometric shapes of a triangle, a decagon, and an oval. Consequently, the reconstructed images 416 for each of the three wavelengths are also larger in size. The view shown in FIG. 4E is analogous to the top-down view of FIG. 4D, except for the larger target image and, correspondingly, the larger reconstructed images 416.

FIG. 4E illustrates that there is a region 420 (shown in FIG. 4E within a dashed contour) in space within which there is a subregion where a portion of the reconstructed image 416-B for blue light overlaps with a portion of the reconstructed image 416-G for green light and a portion of the reconstructed image 416-R for red light. The region 420 is an area where portions of the reconstructed images 416 for different colors overlap. The illustration of FIG. 4E shows that different portions of the reconstructed images of different colors overlap within the region 420, and that the reconstructed images of different colors are of different sizes compared to one another (similar to the illustration of FIGS. 4C and 4D), which might not yield a proper multi-color holographic representation of the target image. In case the target image for each of the red, green, and blue color channels is properly scaled before hologram computation, the reconstructed image of each of the red, green, and blue color channels may exhibit desired dimensions so that the portion of the reconstructed image of the red, green, and blue color channels that overlap with each other are matching in size to properly overlap to yield an accurate multi-color holographic representation of the target image.

Providing the illumination 402 in a way that the directions of the three wavelengths of the illumination 402 are not the same, as shown in FIG. 4D, is not the only way. FIG. 4F illustrates an alternative embodiment, in which the directions of the three wavelengths of the illumination 402 are not the same because the angles between the normal 410 and different ones of the illumination 402-B, the illumination 402-G, and the illumination 402-R are different from one another. For example, as shown in the side view of FIG. 4F, the angle between the normal 410 and the illumination 402-B may be the smallest, the angle between the normal 410 and the illumination 402-G may be larger than the angle between the normal 410 and the illumination 402-B, and the angle between the normal 410 and the illumination 402-R may be larger than the angle between the normal 410 and the illumination 402-G (in other embodiments, the relationship between these angles for illumination 402 of different wavelengths may be different). The top-down view of FIG. 4F illustrates that projections of the illumination 402-B, the illumination 402-G, and the illumination 402-R onto the plane of the SLM array 120 may overlap with one another (i.e., may be similar to the embodiment of FIG. 4C, but different from the embodiment of FIG. 4D). Thus, in the embodiment of FIG. 4F, projections of the illumination 402-B, the illumination 402-G, and the illumination 402-R onto a plane perpendicular to the plane of the SLM array 120 are separated from one another by non-zero angles.

Upon interaction with the SLM array 120, each of the illumination 402-B, the illumination 402-G, and the illumination 402-R produces both a zero-order light 404 (individually labeled in FIG. 4F as zero-order lights 404-R, 404-G, 404-B for red, green, and blue, respectively) and a diffraction order 406 (individually labeled in FIG. 4F as diffraction orders 406-R, 406-G, 406-B for red, green, and blue, respectively). In FIG. 4F, the zero-order images 414 for different ones of the incident illuminations 402-R, 402-G, and 402-B are individually labeled as zero-order images 414-R, 414-G, and 414-B, respectively.

As illustrated in the side view, the illumination 402-R forms the smallest angle relative to the surface of the SLM array 120 among the three beams of the illumination 402; the illumination 402-B forms the largest angle relative to the surface of the SLM array 120, and the illumination 402-G forms an angle relative to the surface of the SLM array 120 that is in between the angles of the illuminations 402-R and 402-B relative to the surface of the SLM array 120. In alternative embodiments, other angular arrangements may be employed. For example, the illumination 402-G or 402-B may form the smallest angle relative to the SLM surface, and/or the illumination 402-R or 402-G may form the largest angle relative to the SLM surface. By way of example, an arrangement may be implemented in which the illumination 402-G forms the smallest angle relative to the surface of the SLM array 120 and the illumination 402-R forms the largest angle relative to the surface of the SLM array 120.

The drawing on the right side of FIG. 4F illustrates a top-down view corresponding to the side view on the left side. In contrast to the top-down view of FIG. 4D, the projections of the illuminations 402-R, 402-G, and 402-B onto the plane of the SLM array 120 overlap, and are collectively represented by a single illumination 402. Accordingly, it should be understood that the illumination 402 shown in the top-down view of FIG. 4F includes multiple wavelength components (e.g., illuminations 402-R, 402-G, and 402-B) that lie within the same plane perpendicular to the SLM surface, while propagating at different angles relative to the SLM surface or relative to the normal 410. Each of the incident illuminations 402-R, 402-G, and 402-B produces a respective zero-order light 404 (e.g., zero-order lights 404-R, 404-G, 404-B for red, green, and blue, respectively) with a corresponding respective zero-order image (e.g., zero-order images 414-R, 414-G, and 414-B for red, green, and blue, respectively), as well as a corresponding respective diffraction order 406 (e.g., diffraction orders 406-R, 406-G, and 406-B for red, green, and blue, respectively) with a corresponding respective reconstructed image (e.g., reconstructed images 416-R, 416-G, and 416-B for red, green, and blue, respectively). Each of the reconstructed images 416-R, 416-G, and 416-B represents the same content, as all three illumination beams illuminate the same hologram pattern encoded on the SLM array 120. However, due to wavelength-dependent diffraction behavior, the reconstructed images 416 for the illuminations 402 of different wavelengths differ in scale. In particular, the reconstructed image 416-R corresponding to red light (having the longest wavelength) is the largest in size, the reconstructed image 416-B corresponding to blue light (having the shortest wavelength) is the smallest in size, and the reconstructed image 416-G corresponding to green light has a size intermediate between those of reconstructed image 416-R and reconstructed image 416-B.

FIG. 4G illustrates a top-down view of an illumination arrangement similar to that of FIG. 4F, but illustrating a larger target image similar to that shown in FIG. 4E. Because the incident illuminations 402-R, 402-G, and 402-B lie within the same plane perpendicular to the SLM array 120, their projections onto the plane of the SLM array 120 overlap in the top-down view. Similar to the top-down view of FIG. 4F, the combined illumination 402 that includes the illuminations 402-R, 402-G, and 402-B is represented in the top-down view of FIG. 4G by a single illumination beam (illumination 402) because projections of the illuminations 402-R, 402-G, and 402-B onto the plane of the SLM array 120 overlap. As described with reference to FIG. 4F (although not directly visible in FIG. 4G), the illumination 402-R forms the smallest angle relative to the SLM surface and produces zero-order light 404-R with zero-order image 414-R and diffraction order 406-R with a corresponding reconstructed image 416-R. The illumination 402-B forms the largest angle relative to the SLM surface and produces zero-order light 404-B with zero-order image 414-B and diffraction order 406-B with reconstructed image 416-B. The illumination 402-G forms an angle relative to the SLM surface intermediate between those of 402-R and 402-B relative to the SLM surface and produces zero-order light 404-G with zero-order image 414-G and diffraction order 406-G with corresponding reconstructed image 416-G.

By appropriately selecting the angular separation between the beams of illuminations 402-R, 402-G, and 402-B in a plane perpendicular to the SLM array 120, portions of the reconstructed images 416-R, 416-G, and 416-B can be made to overlap spatially. In particular, for each reconstructed image, a portion overlaps with portions of the other reconstructed images, although the overlapping portions may correspond to different regions of the respective images. A region in which portions of all three reconstructed images 416-R, 416-G, and 416-B overlap is indicated in FIG. 4G by a region 420, similar to the illustration of FIG. 4E. Within the region 420, overlapping portions of the reconstructed images 416-R, 416-G, and 416-B corresponding to different wavelengths can be combined to form a multi-color representation. For example, in FIG. 4G, within region 420, an oval of the reconstructed image 416-B, a decagon of the reconstructed image 416-G, and a triangle of the reconstructed image 416-R overlap with one another, thereby contributing to a composite color image.

In the embodiment of FIG. 4D, the propagation direction of the illuminations 402-R, 402-G, and 402-B, each having a different central wavelength, overlap with each other when viewed from the side view (e.g., as is shown on the left side of FIG. 4D), but not when viewed from the top-down view (e.g., as is shown on the right side of FIG. 4D). In the embodiment of FIGS. 4F-4G, the propagation direction of the illuminations 402-R, 402-G, and 402-B, each having a different central wavelength, overlap with each other when viewed from the top-down view (e.g., as is shown on the right side of FIG. 4F), but not when viewed from the side view (e.g., as is shown on the left side of FIG. 4F).

FIG. 4H illustrates an alternative embodiment whereby an illumination arrangement is configured with the propagation direction of at least two illumination sources, each having a different central wavelength, being separated from one another in both the side view as well as in the top-down view. Phrased differently, the embodiment shown in FIG. 4H is a combination of the embodiments of FIGS. 4D and 4F. Thus, in the embodiment shown in FIG. 4H, the projections of the propagation directions of at least two illumination sources onto the y-z plane (or a plane parallel to the y-z plane) are at a non-zero angle relative to each other, as in the embodiment of FIG. 4F, as well as the projections of the propagation directions of the same illumination sources of the at least two illumination sources onto the x-y plane (or a plane parallel to the x-y plane) are at a non-zero angle relative to each other, as in the embodiment of FIG. 4D.

In some embodiments, a holographic display system comprises an SLM and an illumination arrangement, wherein the illumination arrangement comprises a first illumination beam and a second illumination beam, the first illumination beam and the second illumination beam having a central wavelength that differ from one another. The first illumination beam is incident on the SLM along a first direction, and the second illumination beam is incident on the SLM along a second direction, the first direction and the second direction being different from one another.

In some embodiments, the first direction and the second direction differ in that projections of the first direction and the second direction onto the SLM top surface, or onto a plane parallel to the SLM top surface, form a non-zero angle relative to each other (e.g., as shown in the embodiments of FIGS. 4D and 4H). In some embodiments, the first direction and the second direction differ in that projections of the first direction and the second direction onto a plane perpendicular to the SLM top surface form a non-zero angle relative to each other (e.g., as shown in the embodiments of FIGS. 4F and 4H). In further embodiments, the first direction and the second direction differ in both that (i) projections of the first direction and the second direction onto the SLM top surface, or onto a plane parallel to the SLM top surface, form a non-zero angle relative to each other, and (ii) projections of the first direction and the second direction onto a plane perpendicular to the SLM top surface form a non-zero angle relative to each other (e.g., as shown in the embodiment of FIG. 4H).

Embodiments of the present disclosure are based on the insight that color holography without color filters and without sequential illumination can be achieved by carefully sizing the input image of the red color channel, the input image of the green color channel, and the input image of the blue color channel of the target image to take into account the wavelength-dependent diffraction behavior. In some embodiments, a hologram pattern for each of the color channels is computed by the use of an FFT, whereby the input image of the red color channel, the input image of the green color channel, and the input image of the blue color channel are carefully resized to form resized input images to FFT matrices for different colors and placing the resized input images for different colors in the suitable place in the FFT matrices. Doing so would ensure that the reconstructed images for red, green, and blue light are of a similar scale to align correctly in space, enabling accurate and consistent multi-color holographically-generated image formation. In some embodiments, the input image of all the color channels are resized. In alternative embodiments, one of the input images of the color channels may remain unsized, while the remaining input images are resized. In an embodiment, an FFT matrix, which can also be referred to as an FFT frame, is a matrix, whereby each value within the matrix is a multi-bit value. In an alternative embodiment, one or more values within an FFT matrix are a complex value. In another alternative example, the positions within an FFT matrix where there is no value corresponding with a resized input image have a value equal to zero. In CGH, FFTs are useful tools used to simulate how light propagates from a virtual object to a hologram plane. However, FFTs are not the only computational method that may be used to generate holograms, and embodiments of the present disclosure may be expanded to other computational CGH methods, all of which are within the scope of the present disclosure.

FIGS. 4A-4H illustrate how directional illumination (i.e., an illumination where different wavelengths are incident on the SLM array 120 at different directions) may enable multi-color holography without the limitations associated with color filters and/or sequential color illumination of a single SLM, or the use of multiple SLM arrays. Unwanted image components produced by the SLM array 120 in this configuration, such as zero-order images, conjugate images, or higher-order diffraction artifacts, may be selectively removed using an aperture (e.g., as implemented by the spatial filter 140) or appropriately designed optical components by not capturing the entire FoV. These components may help ensure that only the desired portion of the holographic RPF contributes to the observer's perception.

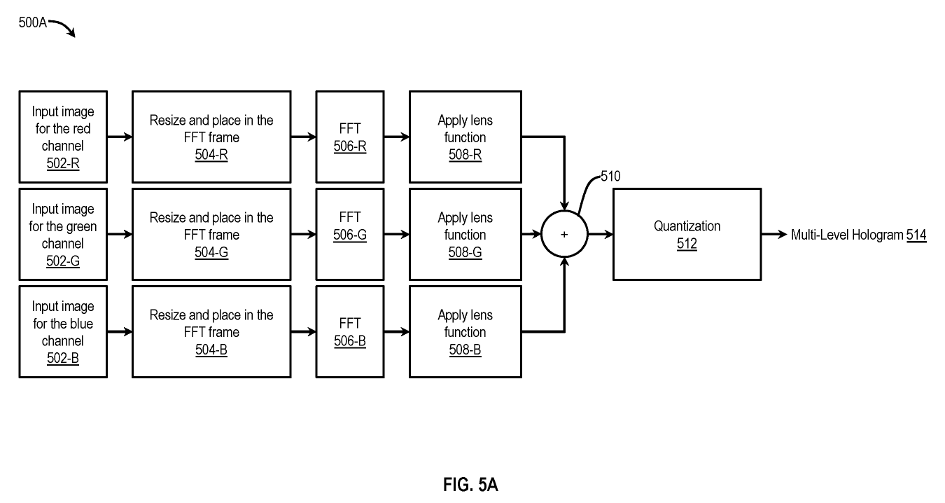

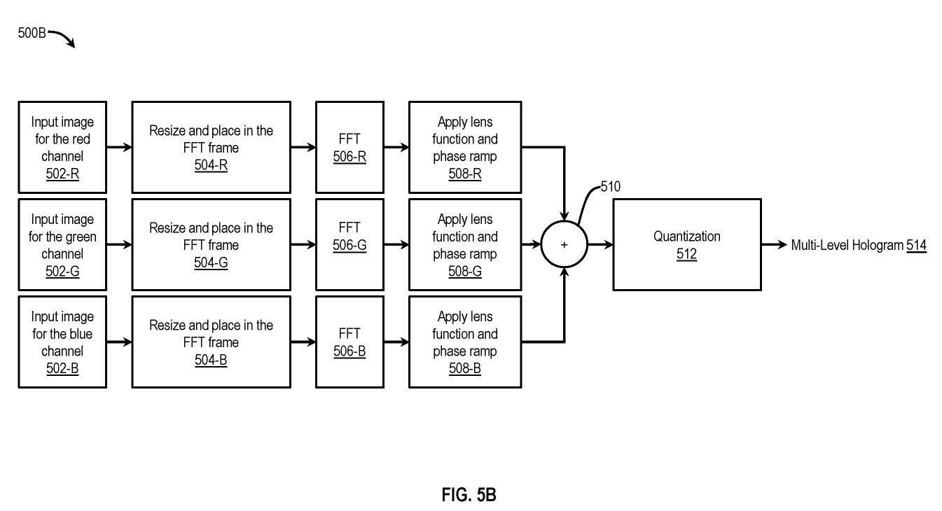

FIGS. 5A and 5B provide schematic illustrations of methods 500A and 500B, implemented by one or more computing systems, for generating holograms for use with a single array of light modulation elements without color filters operable with wavelength-multiplexed illumination, according to some embodiments. The methods 500A and 500B in embodiments where red, green, and blue components of the illumination 402 are separated to be incident on the SLM array 120 from different directions, as described with reference to FIGS. 4D-4H.

FIG. 5A illustrates a method 500A in which steps 502, 504, 506, and 508 are performed separately for each of the color channels, as illustrated with respective alphabetic suffixes. For example, steps 502-R, 504-R, 506-R, and 508-R represent steps 502, 504, 506, and 508, respectively, for the red channel; steps 502-G, 504-G, 506-G, and 508-G represent steps 502, 504, 506, and 508, respectively, for the green channel; and steps 502-B, 504-B, 506-B, and 508-B represent steps 502, 504, 506, and 508, respectively, for the blue channel.

In step 502, a target image is decomposed into an input image corresponding with the red color channel, an input image corresponding with the green color channel, and an input image corresponding with the blue color channel. Phrased differently, in step 502, an input image corresponding with the red color channel, an input image corresponding with the green color channel, and an input image corresponding with the blue color channel are generated based on the target image. The input image of each color channel is provided as an input to step 504. These input images are processed independently to account for the wavelength-dependent behavior of diffracted light.

In step 504, for each color channel separately, the corresponding input image provided in step 502 may be resized appropriately to form a resized input image and placed in a suitable location within an FFT frame for the respective color channel. Phrased differently, in step 504, the input image for each color channel is adjusted to align with the constraints and requirements of hologram computation. Specifically, for each color channel, the input image may be resized to form a resized input image and strategically positioned within a larger two-dimensional frame (referred to as the “FFT frame”) that is used for subsequent domain processing. The resizing and placement are performed in a manner that ensures that (a portion of the) the reconstructed images of different colors will overlap correctly in space (as was described with reference to FIGS. 4E and 4G), thereby producing a well-aligned RGB-color holographically-generated image. This adjustment may compensate for differences in diffraction angles and propagation behavior across the different wavelengths. In some embodiments, by design or convention, one of the color channels, e.g., the green channel, may serve as a reference and the input image of the green color channel may be left unmodified in size in the FFT frame (e.g., the input image of the green color channel may be resized with a factor of 1), while the input images for the other color channels, e.g., for the red and blue channels, are resized and shifted accordingly. This approach may help facilitate precise control over color registration in the final reconstructed image.

In step 506, an FFT is applied to the FFT matrices that are the outputs of step 504, separately for each of the color channels. In an embodiment, the application of the FFT in step 506 transforms the resized input image data from the spatial (image) domain to the frequency domain. In the frequency domain, the complex amplitude and phase information corresponding to the light wavefronts associated with the image are encoded in a way that facilitates the computation of diffraction patterns. By applying the FFT to each color channel independently, the holographic system can properly account for the different wavelengths of light used for each primary color. This separate treatment allows ensuring that the diffraction behavior and propagation characteristics specific to each wavelength are accurately represented in the resulting hologram. The output of step 506 is a complex- or real-valued frequency-domain representation of each color channel, which will be used in subsequent steps to form a single hologram that will drive the SLM array 120 to reconstruct the target image in multi-color.

In step 508, a lens function is applied to the output of the FFT, separately for each of the color channels. In the context of hologram generation, a “lens function” refers to a mathematical complex- or real-valued pattern (e.g., a mathematical phase pattern) that mimics the optical effect of a physical lens. When applied to a hologram (e.g., when applied to an output of the FFT of step 506), e.g., as a phase term in the complex field, it may focus and/or shift in depth the reconstructed image in a controlled manner. In practical terms, adding a lens function during the computation of a hologram may allow controlling where the reconstructed image appears in the 3D space without using a physical lens. The lens function applied in step 508 is wavelength-dependent; hence, different lens functions are used for the red channel, for the green channel, and for the blue channel.

In step 510, the outputs achieved by applying the lens functions to the hologram patterns of individual color channels in step 508 are combined, e.g., by performing an element-wise addition across the corresponding output matrices of step 508. In an embodiment, each lens function modulates the phase of the complex- or real-valued wavefront for its respective color channel (e.g., red, green, or blue), shaping how the light propagates and focusing the reconstructed image at a desired depth or plane in the 3D space. The addition of the hologram pattern of the red channel, of the green channel, and of the blue channel after each being modulated by the lens function, results in a composite hologram pattern that encodes information from all three color channels into a single, unified representation. This composite hologram pattern represents the multi-color hologram in the continuous complex- or real-valued domain.

In step 512, the continuous-valued hologram pattern that is the output of step 510 is quantized to generate a multi-level hologram 514 (e.g., a binary hologram, 2-bit hologram, 4-bit hologram, etc.). The quantization process converts the continuous or real-valued amplitude and/or the continuous or real-valued phase values of the composite hologram into discrete levels, compatible with the hardware capabilities of the SLM. In some embodiments, step 512 may reduce the continuous values of the output of step 510 to a binary format (e.g., 0 and 1), thus generating the hologram 514 as a binary hologram. However, binary holograms represent just one class of holographic encoding, typically used with the SLMs that support only two discrete states, such as binary phase levels or binary amplitude states (e.g., more transparent and more opaque). Binary holograms may be advantageous for their simplicity and compatibility with readily available binary SLMs. However, embodiments of the present disclosure are applicable to systems where the SLM supports multiple levels of phase and/or amplitude modulation. In such scenarios, holograms with multi-bit (e.g., 4-bit or 8-bit) phase information and/or multi-bit amplitude information can be used. These types may allow for greater control over the reconstructed wavefront, potentially leading to higher image fidelity, improved diffraction efficiency, and reduced artifacts.

In various embodiments, the quantization of step 512 may involve error diffusion, thresholding, dithering, or other techniques to preserve as much holographic fidelity as possible while reducing data to a minimal representational format. The hologram 514 can then be displayed on the SLM array 120 to produce the desired multi-color reconstructed image in the physical world.

FIG. 5B illustrates a method 500B that is similar to the method 500A and, therefore, in the interests of brevity, only the differences are described.

Step 502 of the method 500B is substantially the same as step 502 of the method 500A, for each of the color channels.

Step 504 of the method 500B differs from step 504 of the method 500A in that it includes resizing of the input image to form resized input images, as described above for FIG. 5A, but the resized input images for different color channels can be placed anywhere in the FFT frame.

Step 506 of the method 500B is substantially the same as step 506 of the method 500A, for each of the color channels, except that it is applied to a different input (i.e., the output of step 504 in the method 500B is different from that in the method 500A due to the differences in step 504).

Step 508 of the method 500B is similar to step 508 of the method 500A, for each of the color channels, except that it further includes applying a phase ramp, in addition to applying the lens function. Applying a phase ramp in hologram generation refers to introducing a linear phase variation across the hologram plane. This linear phase modulation essentially steers the direction of the diffracted or reconstructed light beam, allowing control over the position of the reconstructed image in space, such as shifting it laterally or changing its propagation angle. Applying the phase ramp in step 508 compensates for not placing the resized input image in the correct locations within the FFT frames in step 504 in order for (a portion of) the reconstructed images corresponding with each color channel to overlap. While applying the lens function controls image depth of the reconstructed image, applying the phase ramp controls image position (e.g., in the x-y plane) in the RPF.

Descriptions of steps 510, 512, and of the hologram 514 of the method 500A are applicable to the method 500B and, therefore, are not repeated.

While embodiments described herein refer to a scenario where red, green, and blue components of the illumination 402 are separated to be incident on the SLM array 120 from different directions, a region 420 where (a portion of) the reconstructed image of the red, a portion of the reconstructed image of the green, and a portion of the reconstructed image of the blue overlap may result when red, green, and blue components of the laser illumination 402 are incident on the SLM array 120 from the same direction.

In some embodiments, SLM array 120 is implemented as an amplitude SLM (e.g., binary or multi-level) or as a binary phase SLM. Upon illumination of a hologram pattern rendered on the amplitude or binary phase SLM, a conjugate image may be present in addition to the desired reconstructed image. A conjugate image refers to an additional, ‘undesired’ reconstructed image corresponding to the complex conjugate of the intended holographic wavefront. It typically appears as an inverted or displaced replica of the desired reconstructed image upon illumination of the hologram pattern. In other embodiments, SLM array 120 is implemented as a multi-level phase SLM, and upon illumination of the multi-level phase SLM, a conjugate image is not necessarily present. In some embodiments, a system may make use of only the conjugate image, or both the desired reconstructed image and the conjugate image.

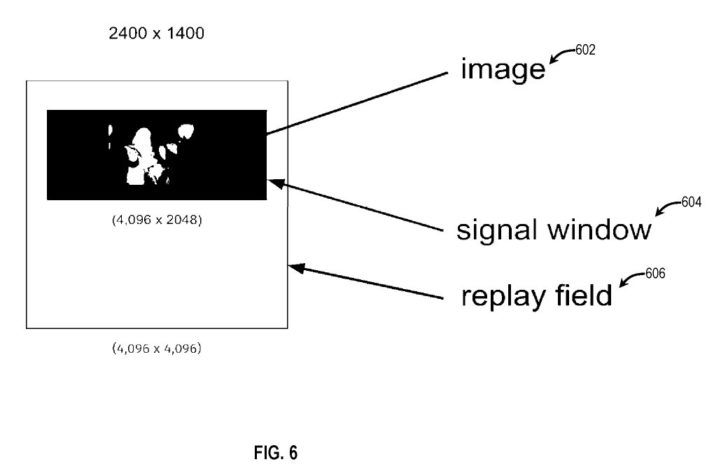

FIG. 6 illustrates an image 602 within a signal window 604 within an RPF 606 for hologram computation, according to some embodiments. The image 602 represents a target image that is desired to be displayed as a holographic reconstructed image in the RPF 606. The signal window, which can also be referred to as a signal region, is the region within the RPF within which a target image can be placed before hologram computation without the corresponding conjugate image overlapping with the target image when the target image is reconstructed by illuminating the SLM. For simplicity, FIG. 6 shows the signal window for the case of 1D off-axis illumination. The size and shape of the signal region, as well as its location within the RPF, is dependent upon the direction of the illumination beam by which the SLM is illuminated. In an embodiment where each color channel corresponds with an illumination beam with a direction different from the direction of the illumination beams of the other color channels, the signal region of each color channel will be different within the RPF. The signal window 604 is a window within an FFT frame (e.g., the FFT frame of step 504 of the methods 500A-B) in which the image 602 may be placed. The positioning of the image 602 within the signal window 604 defines the alignment of the desired reconstructed image within the RPF 606, affecting where the final holographically-generated image will appear when reconstructed. In some embodiments, the dimensions of the image 602, which may be, for example, 2400 x 1400 pixels (with, for example, each pixel being 8bits), are smaller than the dimensions of the signal window 604, which in the case of FIG. 6 is 4096 x 2048 pixels. The signal window 604 itself is also smaller than the RPF 606, whose dimensions are shown in FIG. 6 as 4096 x 4096 pixels. This arrangement may allow for flexibility and spatial optimization within the holographic setup. By appropriately placing the image 602 within the signal window 604, the system ensures that the holographic reconstruction process will result in a clear final image, with the target image positioned correctly within the larger RPF 606. It should be noted that FIG. 6 is explained under the assumption that a conjugate image will be present upon illumination of the hologram pattern as rendered on the SLM. For the case where no conjugate image will be present, the signal window can have the same size as the RPF.

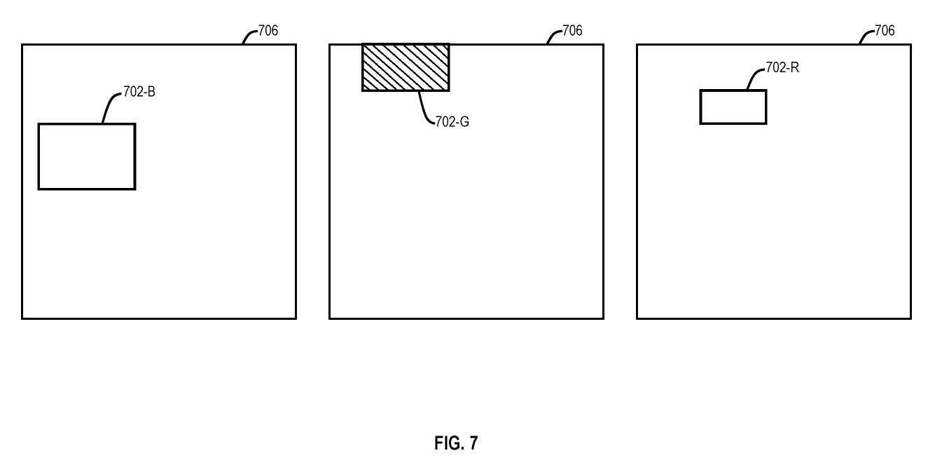

FIG. 7 provides illustrations of example resized input images 702 for hologram computation for different color channels, according to some embodiments. The resized input images 702 are individually labeled in FIG. 7 as a resized input image 702-R for the red light, a resized input image 702-G for the green light, and a resized input image 702-B for the blue light. FIG. 7 illustrates that although the resized input images 702 for different color channels are generated based on the same target image, their sizes and positions within the FFT frames differ for different color channels, in accordance with the descriptions provided above (e.g., as described with reference to step 504 of the method 500A). The larger box 706 shown for each of the resized input images 702 in FIG. 7 may represent a RPF, e.g., the RPF 606, described above. Alternatively, the larger box 706 shown for each of the resized input images 702 in FIG. 7 may represent the output of steps 504 of the methods 500A-B for different color channels.

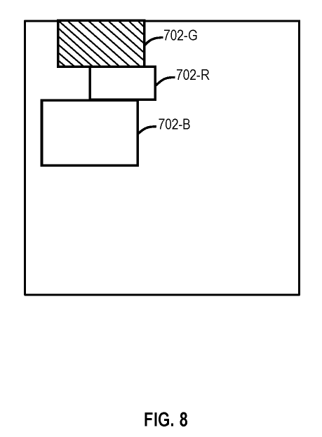

FIG. 8 provides an illustration of a superposition of the resized input images of FIG. 7, according to some embodiments. Thus, FIG. 8 illustrates a combination of the resized input images 702-R, 702-G, and 702-B of FIG. 7.

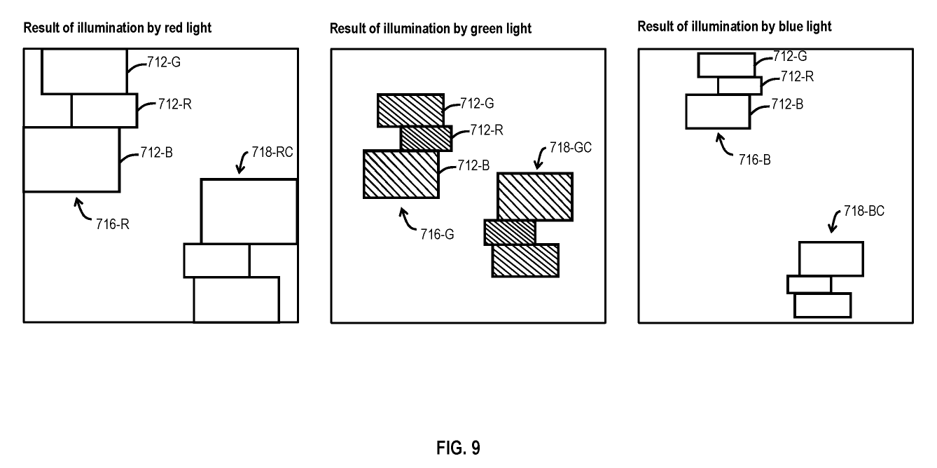

FIG. 9 provides illustrations of reconstructed images resulting from illumination of the hologram 514 of methods 500A and 500B (e.g., hologram displayed on the SLM array 120) by only red, only green, and only blue light, according to some embodiments. For each of the colors, FIG. 9 illustrates reconstructed images 716, where reconstructed images 716 are individually labeled in FIG. 9 as a reconstructed image 716-R for a reconstructed image generated by the SLM array 120 when the array is illuminated by red light only, as a reconstructed image 716-G for a reconstructed image generated by the SLM array 120 when the array is illuminated by green light only, and as a reconstructed image 716-B for a reconstructed image generated by the SLM array 120 when the array is illuminated by blue light only. The reconstructed images 716 may be analogous to the reconstructed images 416, described above. Similar to the reconstructed images 416, the reconstructed images 716 for different colors differ in their sizes and locations. Specifically, the blue diffraction order produces the smallest reconstructed image 716-B, the red diffraction order produces the largest reconstructed image 716-R, and the green diffraction order produces a reconstructed image 716-G that has a size that falls in between the size of the blue and the red. As described above, this variation in scale arises because the diffraction angle is directly proportional to the wavelength of the incident light, meaning shorter wavelengths (e.g., blue) result in smaller diffraction angles and smaller reconstructed images, while longer wavelengths (e.g., red) result in larger diffraction angles and larger reconstructed images. In other words, the variation in size of the reconstructed image for each color arises because the diffraction angles scale with the wavelength.

While FIG. 9 illustrates how the sizes and locations of the reconstructed images 716 for different colors are different, the shapes of the reconstructed images 716 for different colors are substantially the same, each having a portion representing the combination of the input images 702-R, 702-G, and 702-B of FIG. 7. This is due to the fact that a single SLM array (e.g., the SLM array 120) displays a hologram (e.g., the hologram 514) that includes portions indicative of the input images for different color channels. In particular, in FIG. 9, a portion 712-R of the reconstructed images 716 is a portion representing the input image 702-R, a portion 712-G of the reconstructed images 716 is a portion representing the input image 702-G, and a portion 712-B of the reconstructed images 716 is a portion representing the input image 702-B.

In some embodiments, for example, for the case where the SLM is an amplitude modulation SLM or a binary phase modulation SLM, a conjugate image may be present in addition to the desired reconstructed images. FIG. 9 illustrates such conjugate images 718 for different color channels, where conjugate images 718 are individually labeled in FIG. 9 as a conjugate image 718-RC for a conjugate image generated by the SLM array 120 when the array is illuminated by red light only, as a conjugate image 718-GC for a conjugate image generated by the SLM array 120 when the array is illuminated by green light only, and as a conjugate image 718-BC for a conjugate image generated by the SLM array 120 when the array is illuminated by blue light only (where “C” in 718-RC, 718-GC, and 718-BC stands for “conjugate”). FIG. 9 does not show zero-order images (similar to the zero-order images 414, described above), or any higher-order diffracted images to not complicate the drawing. In alternative embodiments, no conjugate image may be present when illuminating the SLM. In that case, the conjugate images 718-RC, 718-GC, and 718-BC may not be present in FIG. 9.

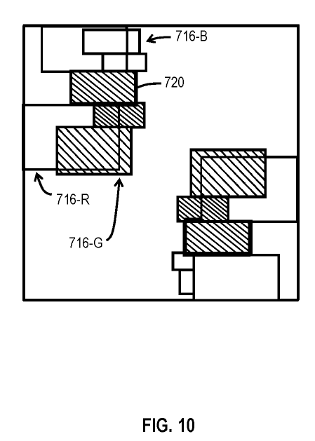

FIG. 10 provides an illustration of a superposition of the reconstructed images 716 of FIG. 9, according to some embodiments. As shown in FIG. 10, there is a region 720 where a portion of the reconstructed image 716-R overlaps with a portion of the reconstructed image 716-G and with a portion of the reconstructed image 716-B. The image in the region 720 is the multi-color reconstructed image that represents the target image. The region 720 is similar to the region 420, described above. Everything else that may be present in the RPF as shown in FIG. 10 may be filtered out, so that substantially only the region 720 is shown.

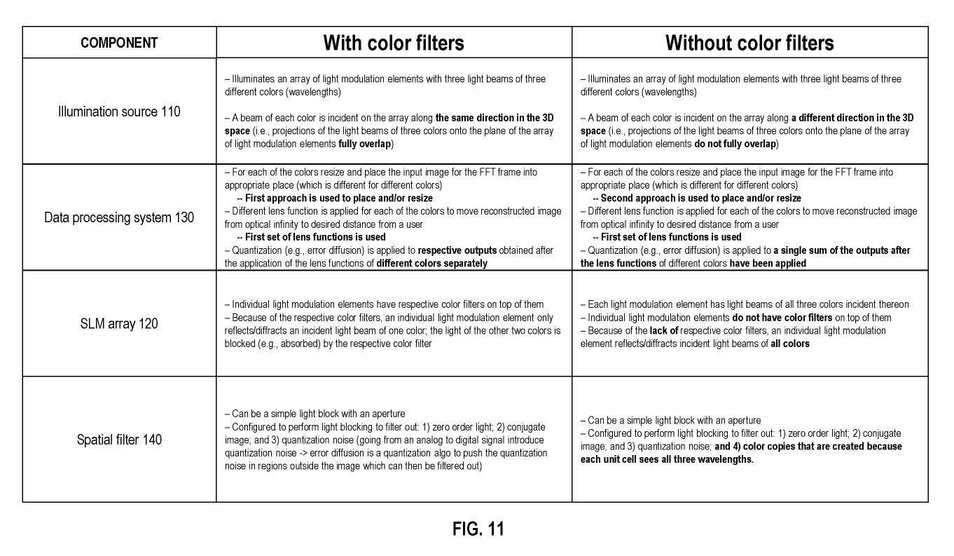

FIG. 11 provides a summary of color holography with and without color filters, according to some embodiments. FIG. 11 illustrates similarities and differences when components such as the illumination source 110, the SLM array 120, the data processing system 130, and the spatial filter 140 operate to realize color holography with and without color filters. FIG. 11 provides an explanation for the case in which the illumination comprises three different wavelengths. Similar differences between color holography with and without color filters are present when the illumination comprises two different wavelengths or more than three different wavelengths. It should be noted that the invention, as described, eliminates the use of color filters for the realization of color holography. However, different embodiments of the invention, whereby one or more light beams, each having a different central wavelength, are incident on an SLM (e.g., SLM array 120) along different directions with respect to each other, can also be combined with color filters applied above the active area of the SLM (e.g., SLM array 120).

Embodiments of the present disclosure are described herein with reference to light of a first light beam having a first wavelength and propagating along a first direction and light of a second light beam having a second wavelength different from the first wavelength and propagating along a second direction different from the first direction, which are relatively simultaneously provided to an SLM. In other embodiments, the light of the first and second light beams may be provided to an SLM sequentially.

The following paragraphs provide examples of various ones of the embodiments disclosed herein.

Example A1 provides a holographic display system that includes a light modulation structure with an array of light modulation elements; and an illumination source, in which: a first light beam from the illumination source has a first center wavelength and is incident onto the light modulation structure along a first direction, a second light beam from the illumination source has a second center wavelength and is incident onto the light modulation structure along a second direction, the second center wavelength is different from the first center wavelength, and an angle between a plane including the first direction and a line perpendicular to the light modulation structure and a plane including the second direction and the line perpendicular to the light modulation structure is greater than 0 degrees.

Example A2 provides the holographic display system according to example A1, in which the angle is greater than 0 degrees and less than 90 degrees.

Example A3 provides the holographic display system according to example A1, in which the angle is greater than 10 degrees and less than 40 degrees.

Example A4 provides the holographic display system according to any one of examples A1-A3, in which: the illumination source includes one or more optical elements configured to ensure that the first light beam from the illumination source is incident onto the light modulation structure along the first direction and the second light beam from the illumination source is incident onto the light modulation structure along the second direction.

Example A5 provides a spatial light modulator, including an array of light modulation elements, in which an individual light modulation element of the array is configured to simultaneously diffract incident light beams having a first center wavelength and incident light beams having a second center wavelength, different from the first center wavelength.

Example A6 provides a light modulation structure, including an array of light modulation elements, in which, during operation of the light modulation structure: incident light beams having a first center wavelength and incident light beams having a second center wavelength, different from the first center wavelength, reach a phase change material of an individual light modulation element of the array.

Example A7 provides an ASIC that includes circuitry to generate a hologram corresponding to a target image; and circuitry to apply the hologram to configure respective states of light modulation elements of a light modulation structure so that, during operation of the light modulation structure, a first reconstructed image based on the target image overlaps at least partially with a second reconstructed image based on the target, in which: the first reconstructed image is a reconstructed image generated based on a first-order diffracted light of a first light beam incident on the light modulation along a first direction, and the second reconstructed image is a reconstructed image generated based on a first-order diffracted light of a second light beam incident on the light modulation along a second direction, the first light beam has a first center wavelength, the second light beam has a second center wavelength different from the first center wavelength, and the second direction is not parallel to the first direction.

Example A8 provides a computer-implemented method, including computing a first hologram pattern for a first color channel of a target image; computing a second hologram pattern for a second color channel of the target image; superimposing the first hologram pattern and the second hologram pattern to form a superimposed hologram pattern; and quantizing the superimposed hologram pattern to generate a hologram.

Example A9 provides a non-transitory computer-readable storage medium, storing instructions to: generate a hologram corresponding to a target image; and apply the hologram to configure respective states of light modulation elements of a light modulation structure so that, during operation of the light modulation structure, a first reconstructed image based on the target image overlaps at least partially with a second reconstructed image based on the target image, in which: the first reconstructed image is a reconstructed image generated based on a first-order diffracted light of a first light beam incident on the light modulation along a first direction, the second reconstructed image is a reconstructed image generated based on a first-order diffracted light of a second light beam incident on the light modulation along a second direction, the first light beam has a first center wavelength, the second light beam has a second center wavelength different from the first center wavelength, and the second direction is not parallel to the first direction.

Example B1 provides a holographic system that includes an SLM with an array of light modulation elements, in which, during operation of the SLM: a first light beam having a first center wavelength is to be incident onto the SLM along a first direction, and a second light beam having a second center wavelength is to be incident onto the SLM along a second direction, in which: the second center wavelength is different from the first center wavelength, a first plane includes the first direction and a line perpendicular to a plane of the SLM, a second plane includes the second direction and the line perpendicular to the plane of the SLM, and an angle between the first plane and the second plane is greater than 0 degrees.

Example B2 provides the holographic system according to example B1, in which the angle between the first plane and the second plane is less than 180 degrees.

Example B3 provides the holographic system according to example B1, in which the angle between the first plane and the second plane is greater than 10 degrees and less than 120 degrees, e.g., greater than 10 degrees and less than 90 degrees.

Example B4 provides the holographic system according to example B1, in which the first center wavelength and the second center wavelength differ by at least 50 nanometers.

Example B5 provides the holographic system according to example B1, in which an angle between the first direction and the plane of the SLM is between 5 degrees and 85 degrees.

Example B6 provides the holographic system according to example B1, in which an angle between the first direction and the plane of the SLM is between 20 degrees and 70 degrees.

Example B7 provides the holographic system according to any one of examples B1-B6, further including one or more optical elements configured to ensure that the first light beam is incident onto the SLM along the first direction and the second light beam is incident onto the SLM along the second direction.

Example B8 provides the holographic system according to any one of examples B1-B6, further including an illumination source configured to provide the first light beam and the second light beam.

Example B9 provides the holographic system according to any one of examples B1-B6, in which, during operation of the SLM, the first light beam and the second light beam are to be incident onto the SLM substantially simultaneously.

Example B10 provides the holographic system according to any one of examples B1-B6, in which an individual light modulation element of the array is configured to simultaneously diffract the first light beam and the second light beam.

Example B11 provides the holographic system according to any one of examples B1-B6, in which an individual light modulation element of the array includes a phase-change material.

Example B12 provides the holographic system according to example B11, in which, during operation of the SLM, the first light beam and the second light beam reach the phase-change material of the individual light modulation element.

Example B13 provides the holographic system according to any one of examples B1-B6, in which a pitch of adjacent light modulation elements of the array is below the first center wavelength or the second center wavelength.

Example B14 provides the holographic system according to any one of examples B1-B6, in which an angle between a projection of the first direction onto the plane of the SLM and a projection of the second direction onto the plane of the SLM is greater than 0 degrees and less than 90 degrees.

Example B15 provides a holographic system, including an SLM having an array of light modulation elements, in which, during operation of the SLM: a first light beam having a first center wavelength is to be incident onto the SLM along a first direction, a second light beam having a second center wavelength is to be incident onto the SLM along a second direction, the second center wavelength is different from the first center wavelength, and an angle between a projection of the first direction onto a plane of the SLM and a projection of the second direction onto the plane of the SLM is greater than 0 degrees.

Example B16 provides the holographic system according to example B15, in which a difference between the first center wavelength and the second center wavelength is at least 50 nanometers.

Example B17 provides the holographic system according to example B15, in which an angle between the first direction and the plane of the SLM is between 5 degrees and 85 degrees.

Example B18 provides a holographic system, including an SLM having an array of light modulation elements, in which, during operation of the SLM: a first light beam having a first center wavelength is to be incident onto the SLM along a first direction, and a second light beam having a second center wavelength is to be incident onto the SLM along a second direction, in which the second center wavelength is different from the first center wavelength, the first direction is at a first angle with respect to a plane of the SLM, the second direction is at a second angle with respect to the plane of the SLM, and the second angle is different from the first angle.

Example B19 provides the holographic system according to example B18, in which a first plane includes the first direction and a line perpendicular to the plane of the SLM, a second plane includes the second direction and the line perpendicular to the plane of the SLM, and an angle between the first plane and the second plane is greater than 0 degrees.

Example B20 provides the holographic system according to example B19, in which the angle between the first plane and the second plane is less than 180 degrees.

Example B21 provides an SLM having an array of light modulation elements, in which an individual light modulation element of the array is configured to simultaneously diffract incident light beams having a first center wavelength and incident light beams having a second center wavelength, different from the first center wavelength.

Example B22 provides the SLM according to example B21, in which, during operation of the SLM: light beams having the first center wavelength are to be incident on the array along a first direction, light beams having the second center wavelength are to be incident on the array along a second direction, and an angle between a projection of the first direction onto a plane of the array and a projection of the second direction onto the plane is greater than 0 degrees and less than 180 degrees.

Example B23 provides the SLM according to example B21, in which, during operation of the SLM: light beams having the first center wavelength are to be incident on the array along a first direction, light beams having the second center wavelength are to be incident on the array along a second direction, a first plane includes the first direction and a line perpendicular to a plane of the array, a second plane includes the second direction and the line perpendicular to the plane of the array, and an angle between the first plane and the second plane is greater than 0 degrees and less than 180 degrees.

Example B24 provides the SLM according to example B21, in which, during operation of the SLM: light beams having the first center wavelength are to be incident on the array along a first direction, light beams having the second center wavelength are to be incident on the array along a second direction, the first direction is at a first angle with respect to a plane of the array, the second direction is at a second angle with respect to the plane of the array, and the second angle is different from the first angle.

Example B25 provides the SLM according to example B24, in which, during operation of the SLM: an angle between a projection of the first direction onto a plane of the array and a projection of the second direction onto the plane is greater than 0 degrees and less than 180 degrees.

Example B26 provides a light modulation structure, including an array of light modulation elements, in which, during operation of the light modulation structure: incident light beams having a first center wavelength and incident light beams having a second center wavelength, different from the first center wavelength, reach a phase change material of an individual light modulation element of the array.

Example B27 provides a hardware component, including circuitry to generate a hologram corresponding to a target image; and circuitry to apply the hologram to configure respective states of light modulation elements of a light modulation structure so that, during operation of the light modulation structure, a first reconstructed image based on the target image overlaps at least partially with a second reconstructed image based on the target image, in which: the first reconstructed image is a reconstructed image generated based on a first-order diffracted light of a first light beam incident on the light modulation along a first direction, the second reconstructed image is a reconstructed image generated based on a first-order diffracted light of a second light beam incident on the light modulation along a second direction, the first light beam has a first center wavelength, the second light beam has a second center wavelength different from the first center wavelength, and the second direction is not parallel to the first direction.

Example B28 provides a computer-implemented method, including computing a first hologram pattern for a first color channel of a target image; computing a second hologram pattern for a second color channel of the target image; superimposing the first hologram pattern and the second hologram pattern to form a superimposed hologram pattern; and quantizing the superimposed hologram pattern to generate a hologram.

Example B29 provides a non-transitory computer-readable storage medium, storing instructions to: generate a hologram corresponding to a target image; and apply the hologram to configure respective states of light modulation elements of a light modulation structure so that, during operation of the light modulation structure, a first reconstructed image based on the target image overlaps at least partially with a second reconstructed image based on the target image, in which: the first reconstructed image is a reconstructed image generated based on a first-order diffracted light of a first light beam incident on the light modulation along a first direction, the second reconstructed image is a reconstructed image generated based on a first-order diffracted light of a second light beam incident on the light modulation along a second direction, the first light beam has a first center wavelength, the second light beam has a second center wavelength different from the first center wavelength, and the second direction is not parallel to the first direction.

The foregoing description of illustrative embodiments, as well as the description of the Abstract, is not intended to be exhaustive or to restrict the scope of the disclosure to the specific implementations presented. Although particular examples and embodiments have been provided for clarity and illustration, those skilled in the relevant technical field will recognize that various alternative approaches, modifications, and equivalent variations may be made without departing from the scope of the disclosure. Such modifications are considered to fall within the breadth and spirit of the concepts described above.

1. A holographic system, comprising:
a spatial light modulator (SLM) comprising an array of light modulation elements,
wherein, during operation of the SLM:
a first light beam having a first center wavelength is to be incident onto the SLM along a first direction, and
a second light beam having a second center wavelength is to be incident onto the SLM along a second direction,
wherein:
the second center wavelength is different from the first center wavelength,
a first plane includes the first direction and a line perpendicular to a plane of the SLM,
a second plane includes the second direction and the line perpendicular to the plane of the SLM, and
an angle between the first plane and the second plane is greater than 0 degrees.

2. The holographic system according to claim 1, wherein the angle between the first plane and the second plane is less than 180 degrees.

3. The holographic system according to claim 1, wherein the angle between the first plane and the second plane is greater than 10 degrees and less than 120 degrees.

4. The holographic system according to claim 1, wherein the first center wavelength and the second center wavelength differ by at least 50 nanometers.

5. The holographic system according to claim 1, wherein an angle between the first direction and the plane of the SLM is between 5 degrees and 85 degrees.

6. The holographic system according to claim 1, wherein an angle between the first direction and the plane of the SLM is between 20 degrees and 70 degrees.

7. The holographic system according to claim 1, further comprising:
one or more optical elements configured to ensure that the first light beam is incident onto the SLM along the first direction and the second light beam is incident onto the SLM along the second direction.

8. The holographic system according to claim 1, further comprising:
an illumination source configured to provide the first light beam and the second light beam.

9. The holographic system according to claim 1, wherein, during operation of the SLM, the first light beam and the second light beam are to be incident onto the SLM substantially simultaneously.

10. The holographic system according to claim 1, wherein an individual light modulation element of the array is configured to simultaneously diffract the first light beam and the second light beam.

11. The holographic system according to claim 1, wherein an individual light modulation element of the array includes a phase change material.

12. The holographic system according to claim 11, wherein, during operation of the SLM, the first light beam and the second light beam reach the phase change material of the individual light modulation element.

13. The holographic system according to claim 1, wherein a pitch of adjacent light modulation elements of the array is below the first center wavelength or the second center wavelength.

14. The holographic system according to claim 1, wherein an angle between a projection of the first direction onto the plane of the SLM and a projection of the second direction onto the plane of the SLM is greater than 0 degrees and less than 90 degrees.

15. A holographic system, comprising:
a spatial light modulator (SLM) comprising an array of light modulation elements,
wherein, during operation of the SLM:
a first light beam having a first center wavelength is to be incident onto the SLM along a first direction,
a second light beam having a second center wavelength is to be incident onto the SLM along a second direction,
the second center wavelength is different from the first center wavelength, and
an angle between a projection of the first direction onto a plane of the SLM and a projection of the second direction onto the plane of the SLM is greater than 0 degrees.

16. The holographic system according to claim 15, wherein a difference between the first center wavelength and the second center wavelength is at least 50 nanometers.

17. The holographic system according to claim 15, wherein an angle between the first direction and the plane of the SLM is between 5 degrees and 85 degrees.

18. A holographic system, comprising:
a spatial light modulator (SLM) comprising an array of light modulation elements,
wherein, during operation of the SLM:
a first light beam having a first center wavelength is to be incident onto the SLM along a first direction, and
a second light beam having a second center wavelength is to be incident onto the SLM along a second direction,
wherein:
the second center wavelength is different from the first center wavelength,
the first direction is at a first angle with respect to a plane of the SLM,
the second direction is at a second angle with respect to the plane of the SLM, and
the second angle is different from the first angle.

19. The holographic system according to claim 18, wherein:
a first plane includes the first direction and a line perpendicular to the plane of the SLM,
a second plane includes the second direction and the line perpendicular to the plane of the SLM, and
an angle between the first plane and the second plane is greater than 0 degrees.

20. The holographic system according to claim 19, wherein the angle between the first plane and the second plane is less than 180 degrees.
